(19) United States
(12) Patent Application Publication
(10) Pub. No.: US 2023/0413260 A1
(43) Pub. Date: Dec. 21, 2023

(54) METHODS FOR FEEDBACK CONFIGURATION, TERMINAL DEVICE, NETWORK DEVICE, AND COMPUTER READABLE MEDIA

(71) Applicant: Lenovo (Beijing) Limited, Beijing (CN)

(72) Inventor: Haipeng Lei, Beijing (CN)

(73) Assignee: Lenovo (Beijing) Limited, Beijing (CN)

(21) Appl. No.: 18/249,288

(22) PCT Filed: Oct. 22, 2020
(86) PCT No.: PCT/CN2020/122825

§ 371 Date: Apr. 17, 2023

(51) Int. Cl. H04W 72/12; H04W 72/20; H04W 4/06

(52) U.S. Cl. CPC H04W 72/12; H04W 72/20; H04W 4/06

(57) ABSTRACT

Embodiments of the present disclosure relate to a solution for a feedback configuration for a channel transmission between a network device and a plurality of terminal devices. In a method for communication in accordance with the embodiments of the present disclosure, a terminal device receives control information from a network device. The control information is used for scheduling a shared channel transmission common to a plurality of terminal devices including the terminal device. Then, the terminal device determines a feedback configuration based on the control information. The feedback configuration indicates whether feedback for the shared channel transmission is enabled or disabled. Afterwards, the terminal device performs a communication with the network device based on the feedback configuration. In this way, the feedback function can be flexibly enabled or disabled and thus a good tradeoff between transmission reliability and resource overhead can be achieved, thereby improving the performance of the communication.

### FIELD

Embodiments of the present disclosure generally relate to the field of communication, and in particular to methods for feedback configuration, a terminal device, a network device, and computer readable media.

### BACKGROUND

5G New Radio (NR) is the 5th generation mobile network. It is a new global wireless standard after 1G, 2G, 3G, and 4G networks. 5G enables a new kind of network that is designed to connect virtually everyone and everything together including machines, objects, and devices. 5G wireless technology is meant to deliver higher multi-Gbps peak data speeds, ultra-low latency, more reliability, massive network capacity, increased availability, and a more uniform user experience to more users. Higher performance and improved efficiency empower new user experiences and connects new industries.

The 3rd Generation Partnership Project (3GPP) Release 17 (Rel-17) Work Item Description (WID) of NR Multicast and Broadcast Services includes various objectives. One of the objectives is to specify Radio Access Network (RAN) basic functions for broadcast/multicast for UEs in RRC_CONNECTED state. Meanwhile, more objectives are studied to specify required changes to improve reliability of Broadcast/Multicast service.

### SUMMARY

In general, embodiments of the present disclosure provide a solution for a feedback configuration for a channel transmission, especially a multicast or broadcast transmission, between a network device and a plurality of terminal devices.

In a first aspect, there is provided a method performed by a terminal device. The method comprises receiving, from a network device, control information for scheduling a shared channel transmission common to a plurality of terminal devices including the terminal device. The method also comprises determining, based on the control information, a feedback configuration indicating whether feedback for the shared channel transmission is enabled or disabled. The method further comprises performing a communication with the network device based on the feedback configuration.

In a second aspect, there is provided a method performed by a network device. The method comprises determining a feedback configuration indicating whether feedback for a shared channel transmission is enabled or disabled, the shared channel transmission being common to a plurality of terminal devices. The method also comprises generating control information for scheduling the shared channel transmission and indicating the feedback configuration. The method further comprises transmitting the control information to at least one of the plurality of terminal devices.

In a third aspect, there is provided a terminal device. The terminal device comprises a processor and a memory storing instructions. The memory and the instructions are configured, with the processor, to cause the terminal device to perform the method of the first aspect.

In a fourth aspect, there is provided a network device. The network device comprises a processor and a memory storing instructions. The memory and the instructions are configured, with the processor, to cause the network device to perform the method of the second aspect.

In a fifth aspect, there is provided a computer readable medium. The computer readable medium has instructions stored thereon. The instructions, when executed on at least one processor of a device, causing the device to perform the method of the first aspect.

In a sixth aspect, there is provided a computer readable medium. The computer readable medium has instructions stored thereon. The instructions, when executed on at least one processor of a device, causing the device to perform the method of the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIGS. 1A to 1C illustrate schematic diagrams of a communication environment in which some embodiments of the present disclosure can be implemented, respectively;

FIG. 2 illustrates an example communication process between a network device and a terminal device in accordance with some embodiments of the present disclosure;

FIG. 3 illustrates an example structure of control information in which a feedback timing indicator is reused to indicate a feedback configuration in accordance with some embodiments of the present disclosure;

FIG. 4 illustrates an example structure of control information in which a feedback resource indicator is reused to indicate a feedback configuration in accordance with some embodiments of the present disclosure;

FIG. 5A illustrates an example structure of control information in which a dedicated field is used to indicate a feedback configuration in accordance with some embodiments of the present disclosure;

FIG. 5B illustrates an example structure of the dedicated field in accordance with some embodiments of the present disclosure;

FIG. 6 illustrates a flowchart of an example method for communication in accordance with some embodiments of the present disclosure;

FIG. 7 illustrates a flowchart of another example method for communication in accordance with some embodiments of the present disclosure; and

FIG. 8 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” and the like indicate that the embodiment described may include a particular feature, structure, or characteristic, but it is not necessary that every embodiment includes the particular feature, structure, or characteristic. Moreover, such phrases do not necessarily refer to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than limitation, a terminal device may also be referred to as a communication device, user equipment (UE), an end user device, a subscriber station (SS), an unmanned aerial vehicle (UAV), a portable subscriber station, a mobile station (MS), or an access terminal (AT). The terminal device may include, but not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (loT) device, a watch or other wearable, a head-mounted display (HMD), a vehicle, a drone, a medical device and application (for example, a remote surgery device), an industrial device and application (for example, a robot and/or other wireless devices operating in an industrial and/or an automated processing chain contexts), a consumer electronics device, a device operating on commercial and/or industrial wireless networks, and the like. In the following description, the terms “terminal device,” “communication device,” “terminal,” “user equipment” and “UE” may be used interchangeably.

As mentioned above, an objective of the Rel-17 WID is to specify required changes to improve reliability of Broadcast/Multicast service. The inventor(s) find that the reliability of such Broadcast/Multicast service can be improved by uplink feedback from UEs. More particularly, the hybrid automatic repeat request (HARQ)-acknowledgement (ACK) feedback from UEs corresponding to a downlink multicast or broadcast transmission may be essential for the multicast or broadcast services in order to satisfy a quality of service (QoS) requirement, for example, a reliability requirement.

Furthermore, it would be advantageous that a level of reliability can be based on requirements of an application/service which is provided by Multicast and Broadcast Services (MBS). In the MBS communications, Group-Radio Network Temporary Identifier (G-RNTI) may be introduced for the MBS so that a UE can differentiate the downlink control information (DCI) scheduling an MBS Physical Downlink Shared Channel (PDSCH) from the DCI scheduling a unicast PDSCH. In detail, the Cyclic Redundancy Check (CRC) of the DCI scheduling an MBS PDSCH can be scrambled by the G-RNTI and the scheduled MBS PDSCH can be scrambled by the G-RNTI.

In RAN1 #102-e meeting, the following agreements are made for HARQ-ACK feedback. For RRC_CONNECTED UEs, HARQ-ACK feedback can be supported for multicast and no additional evaluation may be needed to justify this. The detailed HARQ-ACK feedback solutions, for example, ACK/NACK based solutions, NACK-only based solutions, and the like are for future study. Whether the HARQ-ACK feedback can be optionally disabled and/or enabled is also for future study.

Regarding the HARQ-ACK feedback for a PDSCH carrying a multicast service, there may be two options, which may be also referred to as feedback transmission schemes in the following. The first option (also termed as Option 1 or the first feedback transmission scheme) can be referred to as group NACK transmissions, in which if the PDSCH is successfully received, then a UE does not transmit HARQ-ACK feedback to a gNB, whereas if the PDSCH is not successfully received, then the UE transmits a NACK to the gNB, and a group of UEs share the same resource to transmit a NACK. The second option (also termed as Option 2 or the second feedback transmission scheme) can be referred to as UE-specific ACK/NACK transmissions, in which if the PDSCH is successfully received, then the UE transmits an ACK to the gNB, whereas if the PDSCH is not successfully received, then the UE transmits a NACK to the gNB, and each UE is provided with a UE-specific Physical Uplink Control Channel (PUCCH) resource for the UE to transmit an ACK/NACK to the gNB.

Through a study and analysis on the traditional solutions, the inventor(s) find that it would be advantageous to allow a network device (for example, a gNB) and terminal devices (for example, UEs) in communication with the network device to flexibly enable or disable the feedback function for a transmission from the network device to the terminal devices. For example, it would be advantageous that the network device can enable or disable HARQ-ACK feedback based on a service reliability requirement of the communications. More particularly, when the service reliability requirement for a multicast or broadcast service between the network device and the terminal devices is relatively high, then it is better to enable the feedback function so as to ensure the reliability requirement. Otherwise, if the service reliability requirement is relatively low, it is better to disable the feedback function so as to reduce resource overhead.

Further, the inventor(s) find that the above-mentioned first option can minimize the HARQ-ACK feedback overhead, but the gNB cannot differentiate which UE transmits the NACK in the shared PUCCH resource. In contrast, the above-mentioned second option has minor standardization effort, and the gNB can differentiate each UE's ACK or NACK at the cost of UE-specific PUCCH resource reservations, thereby improving the transmission reliability of the PDSCH. However, when a large number of UEs are receiving the multicast or broadcast transmission, too many PUCCH resources will be consumed if a UE-specific PUCCH resource is configured for each UE for HARQ-ACK feedback corresponding to the multicast or broadcast transmission. In this event, it does make sense to adopt a group-based NACK transmission as defined in the first option. Accordingly, the inventor(s) find that it would be further advantageous to allow the network device and the terminal devices to flexibly switch among different feedback transmission schemes, such as the first and second options as described above.

In view of the above findings by the inventor(s) and in order to solve the problems in the traditional solutions, embodiments of the present disclosure provide a solution for a feedback configuration for a channel transmission, especially a multicast or broadcast transmission, between a network device and a plurality of terminal devices. For example, the network device may indicate the feedback configuration in control information and the terminal devices can determine the feedback configuration from the control information, thereby the network device can inform the terminal devices whether the feedback function is enabled or disabled. In some embodiments, if the feedback function is to be enabled by the network device, the feedback configuration can be used by the network device to further indicate a feedback transmission scheme to the terminal devices.

In particular, in the solution of the present disclosure, the network device may determine the feedback configuration. The feedback configuration can indicate whether feedback for a shared channel transmission is enabled or disabled. The shared channel transmission is common to the plurality of terminal devices. Then, the network device may generate the control information for scheduling the shared channel transmission and indicating the feedback configuration. Next, the network device can transmit the control information to one or more of the plurality of terminal devices. At a terminal device of the plurality of terminal devices, the terminal device may receive the control information from the network device. Then, the terminal device can determine the feedback configuration based on the control information. Afterwards, the terminal device may perform a communication with the network device based on the feedback configuration.

Through the solution of the present disclosure, a switch mechanism can be introduced which allows the network device and the plurality of terminal devices to enable or disable the feedback for the shared channel transmission. In this way, the network device and the plurality of terminal devices can flexibly switch between the enabling and disabling of the feedback function (for example, the HARQ-ACK feedback), so as to reach a fine tradeoff between transmission reliability and resource overhead, thereby improving performance of the communications between the network device and the plurality of terminal devices. Principles and implementations of embodiments of the present disclosure will be described in detail below with reference to the figures.

### Example Environment

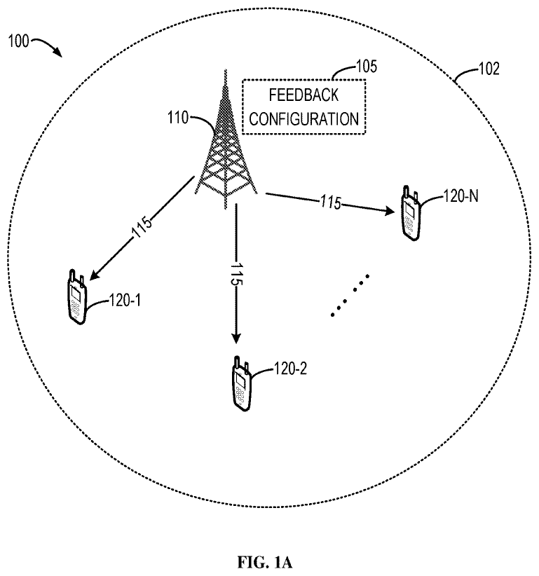

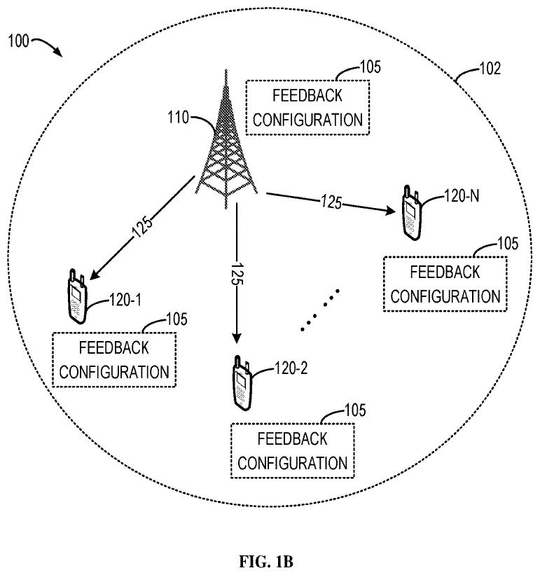

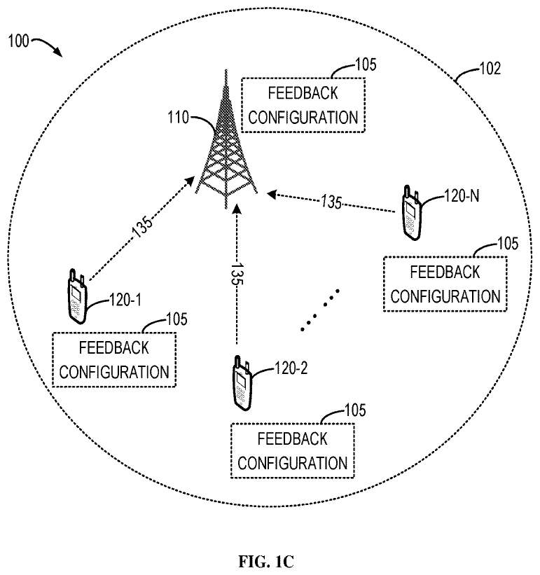

FIGS. 1A to 1C illustrate schematic diagrams of a communication environment 100 in which some embodiments of the present disclosure can be implemented, respectively. As shown in FIG. 1A, the communication environment 100, which may also be referred to as a communication network 100 or a communication system 100, includes a network device 110 serving terminal devices 120-1 to 120-N located in a cell 102 of the network device 110. In the following, the terminal devices 120-1 to 120-N can be collectively referred to as terminal devices 120 for simplicity. For transmissions of data, control information, or the like, the network device 110 can perform communications with one or more of the terminal devices 120.

Transmissions from the network device 110 to the terminal devices 120 may be referred to as downlink transmissions, and the communication channels for the downlink transmissions may be referred to as downlink channels. In contrast, transmissions from the terminal devices 120 to the network device 110 may be referred to as uplink transmissions, and the communication channels for the uplink transmissions may be referred to as uplink channels. Additionally, two or more of the terminal devices 120 can perform sidelink transmissions with each other via device-to-device (D2D) channels, which may also be referred to as sidelink channels.

In some embodiments, the communications between the network device 110 and the terminal devices 120 can be multicast or broadcast communications. In other words, the network device 110 can provide a multicast or broadcast service for the terminal devices 120, such as a Multicast and Broadcast Service (MBS) as defined in 5G NR. In the multicast or broadcast communications, the network device 110 can transmit a shared channel transmission common to the terminal devices 120, that is, the shared channel transmission may be intended for all of the terminal devices 120. As used herein, a shared channel may refer to a communication channel between a network device and a terminal device for carrying communication data and sometimes also carrying control information for communications between the network device and the terminal device. In some embodiments, the shared channel may be various PDSCHs as defined in the 3GPP specifications. For example, the shared channel transmission common to the terminal devices 120 may be a transmission of a MBS PDSCH as defined in 5G NR. More generally, the shared channel as used herein can refer to, as appropriate, any communication channel between two communication devices.

In order to transmit the shared channel transmission to the terminal devices 120 in a more reliable way, the network device 110 may determine a feedback configuration 105 for the shared channel transmission. For example, the feedback configuration 105 can indicate whether a feedback function is enabled or disabled for the shared channel transmission. If the feedback function is enabled, the terminal devices 120 may need to provide feedback to the network device 110 whether the shared channel transmission is successfully received by the terminal devices 120. If the feedback function is disabled, the terminal devices 120 may need not to provide such feedback for the shared channel transmission.

As another example content of the feedback configuration 105, if the feedback function is enabled, the feedback configuration 105 can also indicate a feedback transmission scheme for the terminal devices 120 to transmit the feedback to the network device 110. For instance, the feedback transmission scheme can be the first feedback transmission scheme or the second feedback transmission scheme as described hereinbefore. In other embodiments, the feedback transmission scheme may be any scheme for transmitting the feedback either currently known or to be developed in the future. Moreover, although in some embodiments the first and second feedback transmission schemes refer to the group NACK transmission scheme and UE-specific ACK/NACK transmission scheme, respectively, each of the first and second feedback transmission schemes as used herein can be a feedback transmission scheme other than the group NACK transmission scheme and UE-specific ACK/NACK transmission scheme. Further, in addition to the enabling or disabling of the feedback and the feedback transmission scheme, the feedback configuration 105 can also indicate other configuration parameters and settings of the feedback function.

As further shown in FIG. 1A, after determining the feedback configuration 105, the network device 110 may transmit control information 115 to the terminal devices 120. In some embodiments, the control information 115 is configured by the network device 110 to schedule the shared channel transmission to be transmitted to the terminal devices 120. In other words, the control information 115 contains scheduling information of the shared channel transmission. In addition to its scheduling function, the control information 115 is also configured by the network device 110 to indicate the feedback configuration 105 determined by the network device 110. In some embodiments, the control information 115 may be a DCI as defined in 3GPP specifications, for example, TS 38.212. More generally, the control information 115 can be any information for control function either currently known or to be developed in the future.

FIG. 1B shows an example scenario of the communication environment 100 following the example scenario shown in FIG. 1A. In the example scenario of FIG. 1B, based on the received control information 115, the terminal devices 120 have already determined and known the scheduling information of the shared channel transmission 125 to be performed by the network device 110 as well as the feedback configuration 105 for the shared channel transmission 125. In such example scenario, the network device 110 now transmits the shared channel transmission 125 to the terminal devices 120, and the terminal devices 120 may receive the shared channel transmission 125 based on the scheduling information in the control information 115. As described above, in some embodiments, the shared channel transmission 125 may be a transmission of Multicast and Broadcast Services (MBS) PDSCH as defined in 5G NR. More generally, the shared channel transmission 125 may be any channel transmission either currently known or to be developed in the future.

FIG. 1C shows an example scenario of the communication environment 100 following the example scenario shown in FIG. 1B. In the example scenario of FIG. 1C, the terminal devices 120 can transmit feedback 135 for the shared channel transmission 125 to the network device 110 based on the feedback configuration 105. For example, if the feedback configuration 105 indicates that the feedback function is disabled, the terminal devices 120 may receive the shared channel transmission 125 without providing the feedback 135. As another example, if the feedback configuration 105 indicates that the feedback function is enabled and also indicates a feedback transmission scheme, the terminal devices 120 may generate and transmit the feedback 135 according to the feedback transmission scheme. For example, the terminal devices 120 may provide feedback 135 based on the first or second feedback transmission scheme as described herein. In some embodiments, the feedback 135 may be HARQ-ACK feedback for Multicast and Broadcast Services (MBS) PDSCH as defined in 5G NR. More generally, the feedback 135 may be any other feedback information either currently known or to be developed in the future.

Although the network device 110 and the terminal devices 120 are described in the communication environment 100 of FIGS. 1A to 1C, embodiments of the present disclosure may be equally applicable to any other suitable communication devices in communication with one another. That is, embodiments of the present disclosure are not limited to the example scenarios of FIGS. 1A to 1C. In this regard, it is noted that although the network device 110 is schematically depicted as a base station and the terminal devices 120 are schematically depicted as mobile phones in FIGS. 1A to 1C, it is understood that these depictions are only for example without suggesting any limitation. In other embodiments, the network device 110 and the terminal devices 120 may be any other communication devices, for example, any other wireless communication devices.

It is to be understood that the particular number of various communication devices, the particular number of various communication links, and the particular number of other elements as shown in FIGS. 1A to 1C are only for the purpose of illustration without suggesting any limitations. The communication environment 100 may include any suitable number of communication devices, any suitable number of communication links, and any suitable number of other elements adapted for implementing embodiments of the present disclosure. In addition, it would be appreciated that there may be various wireless communications as well as wireline communications (if needed) among all the communication devices.

Communications in the communication environment 100 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example Process

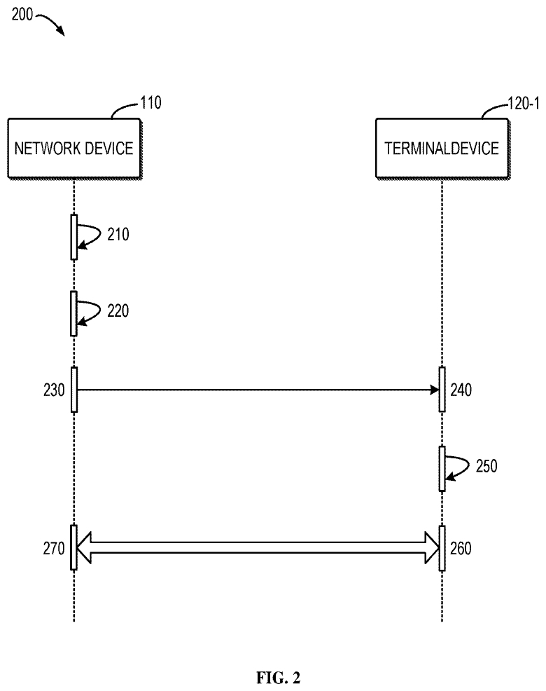

FIG. 2 illustrates an example communication process 200 between the network device 110 and the terminal device 120-1 in accordance with some embodiments of the present disclosure. It is to be understood that although the example communication process 200 is depicted to be performed between the network device 110 and the terminal device 120-1, the example communication process 200 can similarly be performed between the network device 110 and any other terminal device of the terminal devices 120. For the purpose of discussion, the example communication process 200 will be described with reference to FIGS. 1A to 1C. However, it would be appreciated that the example communication process 200 may be equally applicable to other communication scenarios in which two devices can communicate with each other.

As shown in FIG. 2, for the purpose of transmitting the shared channel transmission 125 to the terminal devices 120, the network device 110 may determine (210) the feedback configuration 105 for the shared channel transmission 125. As described above, the feedback configuration 105 can indicate to the terminal devices 120 whether the feedback 135 for the shared channel transmission 125 is enabled or disabled. Therefore, prior to transmitting the shared channel transmission 125, the network device 110 can determine whether the feedback 135 is to be enabled or disabled for the shared channel transmission 125. Disabling of the feedback 135 may mean that the terminal devices 120 can receive the shared channel transmission 125 without providing the feedback 135 for the shared channel transmission 125. On the other hand, enabling of the feedback 135 may mean that the terminal devices 120 need to provide the feedback 135 for the shared channel transmission 125 at least in response to some situations, for example, the terminal devices 120 fails to successfully receive the shared channel transmission 125.

In some embodiments, the network device 110 may determine whether to enable or disable the feedback 135 based on a service reliability requirement. For example, if the service reliability requirement associated with the shared channel transmission 125 is relatively high, then the network device 110 can enable the feedback 135 so as to improve the reliability of the shared channel transmission 125. Otherwise, if the service reliability requirement associated with the shared channel transmission 125 is relatively low, then the network device 110 can alternatively disable the feedback 135 so as to save transmission resources and power of the terminal devices 120. More particularly, if the service reliability requirement is higher than or equal to a predetermined threshold requirement, then the network device 110 may enable the feedback 135. If the service reliability requirement is lower than the predetermined threshold requirement, then the network device 110 can disable the feedback 135. In some other embodiments, the network device 110 can determine whether to enable or disable the feedback 135 based on other possible factors related to the communications between the network device 110 and the terminal devices 120, such as, the capacity of the batteries of the terminal devices 120, the received signal quality of the terminal devices 120, or the like.

Continuing with reference to FIG. 2, after determining (210) the feedback configuration 105, the network device 110 can generate (220) the control information 115 of the shared channel transmission 125. As described, the control information 115 is configured by the network device 110 for both scheduling the shared channel transmission 125 and indicating the feedback configuration 105 for the shared channel transmission 125. In other words, the control information 115 which includes the scheduling information of the shared channel transmission 125 can be reused to indicate the feedback configuration 105 for the shared channel transmission 125. Therefore, it is noted that for the scheduling purpose, the control information 115 may contain various scheduling information fields for scheduling the shared channel transmission 125.

For example, in some embodiments, the control information 115 can be a DCI format as defined in the 3GPP specifications, such as, TS 38.212. In such some embodiments, the control information 115 may include one or more of the following fields or information: Identifier for DCI formats, Frequency domain resource assignment, Random Access Preamble index, UL/SUL indicator, SS/PBCH index, PRACH Mask index, Time domain resource assignment, VRB-to-PRB mapping, Modulation and coding scheme, New data indicator, Redundancy version, HARQ process number, Downlink assignment index, TPC command for scheduled PUCCH, PUCCH resource indicator, PDSCH-to-HARQ_feedback timing indicator, and Reserved bits. The definitions and more details of these fields can be found in the 3GPP specifications. In some other embodiments, the control information 115 can be other DCIs with different formats as defined in the 3GPP specifications. More generally, the control information 115 can be any control information for scheduling function either currently known or to be developed in the future.

In general, there may be various manners for the network device 110 to indicate the feedback configuration 105 in the control information 115. For example, since the control information 115 may include various scheduling information fields for the scheduling function, the network device 110 can reuse a scheduling information field in the control information 115 to indicate the feedback configuration 105 either explicitly or implicitly. Alternatively or additionally, in addition to these scheduling information fields, the network device 110 can create a dedicated field in the control information 115, and employ the dedicated field to indicate the feedback configuration 105 explicitly. Some embodiments of different manners for the network device 110 to indicate the feedback configuration 105 in the control information 115 will be further described hereinafter with reference to FIGS. 3-5.

Subsequent to generating (220) the control information 115, the network device 110 may transmit (230) the control information 115 to one or more of the terminal devices 120. That is, in some embodiments, the control information 115 can be transmitted to all of the terminal devices 120 in a multicast or broadcast manner. However, in some other embodiments, the network device 110 can transmit the control information 115 to some of terminal devices 120 or to only one of the terminal devices 120. For example, the control information 115 can be separately transmitted to different groups of terminal devices of the terminal devices 120, or separately transmitted to individual terminal devices of the terminal devices 120. Without loss of generality, FIG. 2 depicts that the network device 110 transmits (230) the control information 115 to the terminal device 120-1.

Accordingly, from the perspective of the receiving side of the control information 115, the terminal device 120-1 may receive (240) the control information 115 from the network device 110. Since the network device 110 has indicated the feedback configuration 105 in the control information 115, the terminal device 120-1 can determine (250) the feedback configuration 105 based on the received control information 115. For example, from the control information 115, the terminal device 120-1 may determine whether the feedback 135 for the shared channel transmission 125 is enabled or disabled by the network device 110. It is to be understood that the terminal device 120-1 can determine (250) the feedback configuration 105 based on the control information 115 in different manners corresponding to the various manners in which the network device 110 indicates the feedback configuration 105 in the control information 115. Some embodiments of various manners for the terminal device 120-1 to determine (250) the feedback configuration 105 based on the control information 115 will be further described hereinafter with reference to FIGS. 3-5.

After determining (250) the feedback configuration 105, the terminal device 120-1 may perform (260) a communication with the network device 110 based on the feedback configuration 105. For example, if the feedback configuration 105 indicates that the feedback 135 is disabled by the network device 110, then the terminal device 120-1 can receive the shared channel transmission 125 without transmitting the feedback 135 to the network device 110. In this way, the resources for transmitting the feedback 135 can be saved, thereby reducing the resource overhead in the communications between the network device 110 and the terminal devices 120. In this event, the communication between the network device 110 and the terminal device 120-1 may include the shared channel transmission 125 from the network device 110 to the terminal device 120-1.

On the other hand, if the feedback configuration 105 indicates that the feedback 135 is enabled by the network device 110, then the terminal device 120-1 may need to transmit the feedback 135 to the network device 110. In this situation, the communication between the network device 110 and the terminal device 120-1 can include the shared channel transmission 125 from the network device 110 to the terminal device 120-1 and the transmission of the feedback 135 from the terminal device 120-1 to the network device 110.

From the perspective of the other party of the communication, the network device 110 can also perform (270) the communication with the terminal device 120-1 based on the feedback configuration 105. For example, if the feedback 135 is disabled by the network device 110, then the network device 110 can transmit the shared channel transmission 125 to the terminal devices 120 without receiving the feedback 135 from the terminal devices 120 including the terminal device 120-1. On the other hand, if the feedback 135 is enabled by the network device 110, then the network device 110 may need to receive the feedback 135 from the terminal devices 120 including the terminal device 120-1.

In some embodiments, if the network device 110 determines that the feedback 135 is to be enabled, the network device 110 may further determine a feedback transmission scheme for the terminal devices 120 to transmit the feedback 135. Then, the network device 110 can configure the control information 125 to also indicate the feedback transmission scheme. On the terminal device 120-1 side, if the terminal device 120-1 determines from the control information 125 that the feedback 135 is enabled, the terminal device 120-1 may further determine the feedback transmission scheme from the control information 125. Then, the terminal device 120-1 can transmit the feedback 135 to the network device 110 based on the feedback transmission scheme.

Through the example communication process 200, a mechanism may be introduced to allow the network device 110 and the terminal devices 120 to enable or disable feedback in their communications, as well as to dynamically switch between different feedback transmission schemes, for example, the first option and the second option as described above. In this way, the network device 110 and the terminal devices 120 can flexibly enable or disable the feedback function and can flexibly adjust the feedback transmission schemes according to actual communication scenarios, so as to achieve a good tradeoff between transmission reliability and resource overhead, thereby improving performance of the communications between the network device 110 and the terminal devices 120.

As mentioned above, there may be various manners for the network device 110 to indicate the feedback configuration 105 in the control information 115. Accordingly, the terminal device 120-1 can determine (250) the feedback configuration 105 from the control information 115 in different manners corresponding to the various manners in which the network device 110 indicates the feedback configuration 105 in the control information 115. In some embodiments, the network device 110 can reuse a scheduling information field in the control information 115 to indicate the feedback configuration 105 either explicitly or implicitly.

For example, a feedback timing indicator in the control information 115 for indicating the timing of the feedback 135 can be reused to also indicate the feedback configuration 105. In other words, the enabling or disabling of the feedback 135 can be based on a newly designed feedback timing indicator compared to a conventional feedback timing indicator only for indicating the timing of the feedback 135. In this way, both the feedback configuration 105 and the feedback timing can be indicated by the same feedback timing indicator, thereby reducing the signaling overhead of the control information 115. Such an embodiment will be further described below with reference to FIG. 3.

FIG. 3 illustrates an example structure 300 of the control information 115 in which a feedback timing indicator 310 is reused to indicate the feedback configuration 105 in accordance with some embodiments of the present disclosure. As shown in FIG. 3, the control information 115 of the example structure 300 may include the feedback timing indicator 310, other fields 320 before the feedback timing indicator 310, and other fields 330 after the feedback timing indicator 310. It is to be appreciated that the particular position of the feedback timing indicator 310 is only for example without suggesting any limitation. In other embodiments, the feedback timing indicator 310 can be arranged at the beginning or the end of the control information 115.

In some embodiments, the control information 115 of the example structure 300 can be a DCI format as defined in the 3GPP specifications, and the feedback timing indicator 310 may be the PDSCH-to-HARQ_feedback timing indicator in the DCI format. The definitions and more details of the PDSCH-to-HARQ_feedback timing indicator can be found in the 3GPP specifications. More generally, in some other embodiments, the feedback timing indicator 310 can be any indicator for indicating the timing of feedback either currently known or to be developed in the future.

Referring to both FIGS. 2 and 3, in order to reuse the feedback timing indicator 310 in the control information 115 to indicate the determined (210) feedback configuration 105, the network device 110 may set the feedback timing indicator 310 to indicate the feedback configuration 105 when generating (220) the control information 115. Correspondingly, upon receiving (240) the control information 115, the terminal device 120-1 can determine (250) the feedback configuration 105 based on the feedback timing indicator 310 in the control information 115.

In some embodiments, the network device 110 may implicitly indicate the feedback configuration 105 using the feedback timing indicator 310. In this way, there is no need for the network device 110 to predefine or predetermine a value of the feedback timing indicator 310 to indicate the enabling or disabling of the feedback 135, thereby reducing the complexity of the implementations of the network device 110 and the terminal devices 120.

More particularly, if the network device 110 determines that the feedback 135 is to be disabled, the network device 110 may set the feedback timing indicator 310 to have a value indicating an inapplicable feedback timing value. In other words, the terminal devices 120 cannot determine an applicable feedback timing value from the feedback timing indicator 310, and thus is unable to transmit the feedback 135 to the network device 110. Therefore, the terminal devices 120 can implicitly determine that the feedback 135 is disabled by the network device 110. On the other hand, if the network device 110 determines that the feedback 135 is to be enabled, the network device 110 may alternatively set the feedback timing indicator 310 to have a value indicating an applicable feedback timing value. In other words, the terminal devices 120 can determine an applicable feedback timing value from the feedback timing indicator 310, and thus is able to transmit the feedback 135 to the network device 110. Therefore, the terminal devices 120 can implicitly determine that the feedback 135 is enabled by the network device 110.

In some embodiments, the feedback timing indicator 310 may be the PDSCH-to-HARQ_feedback timing indicator in DCI format as defined in the 3GPP specifications, and the shared channel transmission 125 may be an MBS PDSCH transmission. In these embodiments, the network device 110 may configure a set of HARQ-ACK feedback timing values, via radio resource control (RRC) signalling, for the terminal device 120-1 to determine the HARQ-ACK feedback timing corresponding to the MBS PDSCH transmission. For implicitly indicating the disabling of the feedback 135, a non-numerical value or a negative value (for example, “−1”) can be configured in the set of HARQ-ACK feedback timing values, for the network device 110 to disable the HARQ-ACK feedback for the MBS PDSCH transmission.

If the network device 110 determines to disable the HARQ-ACK feedback for the MBS PDSCH transmission, the network device 110 can indicate the non-numerical value or the negative value by setting the PDSCH-to-HARQ_feedback timing indicator in the DCI format to the index of the non-numerical value or the negative value in the set of HARQ-ACK feedback timing values. If the network device 110 determines to enable the HARQ-ACK feedback for the MBS PDSCH transmission, the network device 110 can indicate one numerical value by setting the PDSCH-to-HARQ_feedback timing indicator in the DCI format to the index of the numerical value in the set of HARQ-ACK feedback timing values.

Table 1 as below shows an example of implicit indications of the enabling or disabling of the feedback 135 using the feedback timing indicator 310. In some embodiments, Table 1 can be configured by the network device 110 for the terminal device 120-1 via RRC signaling.

TABLE 1

| Value of feedback | | Enabling or |
|---|---|---|
| timing indicator | | disabling |
| (3 bits) | Feedback timing value | of feedback |
| 000 | Inapplicable timing value | Disabled |
| 001 | Applicable timing value | Enabled |
| 010 | Applicable timing value | Enabled |
| 011 | Applicable timing value | Enabled |
| 100 | Applicable timing value | Enabled |
| 101 | Applicable timing value | Enabled |
| 110 | Applicable timing value | Enabled |
| 111 | Applicable timing value | Enabled |

In the example shown in above Table 1, it is assumed that the feedback timing indicator 310 includes 3 bits and thus can have eight values “000” to “111.” For each of the terminal devices 120 (for example the terminal device 120-1), each of the eight values can indicate a feedback timing value for the terminal device 120-1 to transmit the feedback 135 to the network device 110. It is to be understood that the particular number of bits, the particular feedback timing values, and the particular mappings as shown in Table 1 are only for the purpose of illustration without suggesting any limitations. In other embodiments, the feedback timing indicator 310 can have any number of bits, any inapplicable or applicable feedback timing values, and any mappings to the enabling or disabling of the feedback 135.

As shown in Table 1, in order to disable the feedback 135, the network device 110 can configure the value “000” of the feedback timing indicator 310 to indicate an inapplicable feedback timing value (for example, −1). That is, based on the value “000” of the feedback timing indicator 310, the terminal device 120-1 cannot determine a valid feedback timing value for transmitting the feedback 135, and thus can implicitly determine that the feedback 135 is disabled by the network device 110.

In contrast, as further shown in Table 1, in order to enable the feedback 135, the network device 110 can configure the value “001” of the feedback timing indicator 310 to indicate an applicable feedback timing value. That is, based on the value “001” of the feedback timing indicator 310, the terminal device 120-1 can determine a valid feedback timing value for transmitting the feedback 135, and thus can implicitly determine that the feedback 135 is enabled by the network device 110. Similarly, by setting the values “010” to “111” to indicate different feedback timing values, the network device 110 can configure values “010” to “111” to implicitly indicate to the terminal device 120-1 that the feedback 135 is enabled.

On the receiving side of the control information 115 including the feedback timing indicator 310, if the terminal device 120-1 determines that the feedback timing indicator 310 has a value indicating an inapplicable feedback timing value, the terminal device 120-1 can implicitly determine that the feedback configuration 105 indicates the disabling of the feedback 135. If the terminal device 120-1 determines that the feedback timing indicator 310 has a value indicating an applicable feedback timing value, the terminal device 120-1 can implicitly determine that the feedback configuration 105 indicates the enabling of the feedback 135.

In some embodiments, the feedback timing indicator 310 can be the PDSCH-to-HARQ_feedback timing indicator in DCI format as defined in the 3GPP specifications, and the shared channel transmission 125 may be an MBS PDSCH transmission. In these embodiments, upon reception of the DCI format for scheduling the MBS PDSCH transmission, if a non-numerical value or a negative value is indicated by the PDSCH-to-HARQ_feedback timing indicator, then the terminal device 120-1 may determine the disabling of the HARQ-ACK feedback for the PDSCH, and may not transmit the HARQ-ACK feedback corresponding to the MBS PDSCH transmission. If one numerical value is indicated by the PDSCH-to-HARQ_feedback timing indicator, then the terminal device 120-1 may determine the enabling of the HARQ-ACK feedback for the PDSCH, and transmit the HARQ-ACK feedback in the slot with an offset of the indicated numerical value to the slot where the DCI format is received.

Instead of the above described implicit way, the network device 110 may also explicitly indicate the feedback configuration 105 using the feedback timing indicator 310. As such, the enabling or disabling of the feedback 135 can be indicated and determined in a simple and direct way, thereby simplifying the operations of the network device 110 to configure the feedback timing indicator 310 to indicate the enabling or disabling of the feedback 135, and also simplifying the operations of the terminal devices 120 to determine the enabling or disabling of the feedback 135 based on the feedback timing indicator 310.

More particularly, if the network device 110 determines that the feedback 135 is to be disabled, the network device 110 may set the feedback timing indicator 310 to have a predetermined value. The predetermined value is configured for indicating the disabling of the feedback 135. On the other hand, if the network device 110 determines that the feedback 135 is to be enabled, the network device 110 may alternatively set the feedback timing indicator 310 to have a value different from the predetermined value. Values different from the predetermined value are configured for indicating the enabling of the feedback 135.

In some embodiments, the feedback timing indicator 310 may be the PDSCH-to-HARQ_feedback timing indicator in DCI format as defined in the 3GPP specifications, and the shared channel transmission 125 may be an MBS PDSCH transmission. In these embodiments, one code point of the PDSCH-to-HARQ_feedback timing indicator can be reserved for indicating enabling or disabling the HARQ-ACK feedback for the MBS PDSCH. In this event, the set of HARQ-ACK feedback timing values may not include a non-numerical value or a negative value.

Table 2 as below shows an example of explicit indications of the enabling or disabling of the feedback 135 using the feedback timing indicator 310. In some embodiments, Table 2 can be configured by the network device 110 for the terminal device 120-1 via RRC signaling.

TABLE 2

| Value of feedback timing indicator | |
|---|---|
| (3 bits) | Enabling or disabling of feedback |
| 000 | Enabled |
| 001 | Enabled |
| 010 | Enabled |
| 011 | Enabled |
| 100 | Enabled |
| 101 | Enabled |
| 110 | Enabled |
| 111 | Disabled |

In the example shown in above Table 2, it is assumed that the feedback timing indicator 310 includes 3 bits and thus can have eight values “000” to “111.” For each of the terminal devices 120 (for example the terminal device 120-1), each of the eight values can indicate a feedback timing value for the terminal device 120-1 to transmit the feedback 135 to the network device 110. It is to be understood that the particular number of bits and the particular mappings as shown in Table 2 are only for the purpose of illustration without suggesting any limitations. In other embodiments, the feedback timing indicator 310 can have any number of bits and any mappings to the enabling or disabling of the feedback 135.

As shown in Table 2, the network device 110 can configure the value “111” to be the predetermined value for indicating disabling of the feedback 135. Accordingly, in order to disable the feedback 135, the network device 110 can configure the feedback timing indicator 310 to have the predetermined value 111. In contrast, as further shown in Table 2, in order to enable the feedback 135, the network device 110 can configure the feedback timing indicator 310 to have a value different from the predetermined value 111, for example, one of the values “000” to “110.”

On the receiving side of the control information 115 including the feedback timing indicator 310, if the terminal device 120-1 determines that the feedback timing indicator 310 has the predetermined value (for example, “111”), the terminal device 120-1 can explicitly determine that the feedback configuration 105 indicates the disabling of the feedback 135. If the terminal device 120-1 determines that the feedback timing indicator 310 has a value (for example, one of the values “000” to “110”) different from the predetermined value, the terminal device 120-1 can explicitly determine that the feedback configuration 105 indicates the enabling of the feedback 135.

In some embodiments, the feedback timing indicator 310 can be the PDSCH-to-HARQ_feedback timing indicator in DCI format as defined in the 3GPP specifications, and the shared channel transmission 125 may be an MBS PDSCH transmission. In these embodiments, if a reserved code point (for example, “111”) of the PDSCH-to-HARQ_feedback timing indicator is indicated by the DCI format, the terminal device 120-1 may determine the disabling of the HARQ-ACK feedback for the PDSCH. If a code point (for example, one of the values “000” to “110”) other than the reserved code point of the PDSCH-to-HARQ_feedback timing indicator is indicated by the DCI format, the terminal device 120-1 may determine the enabling of the HARQ-ACK feedback for the PDSCH.

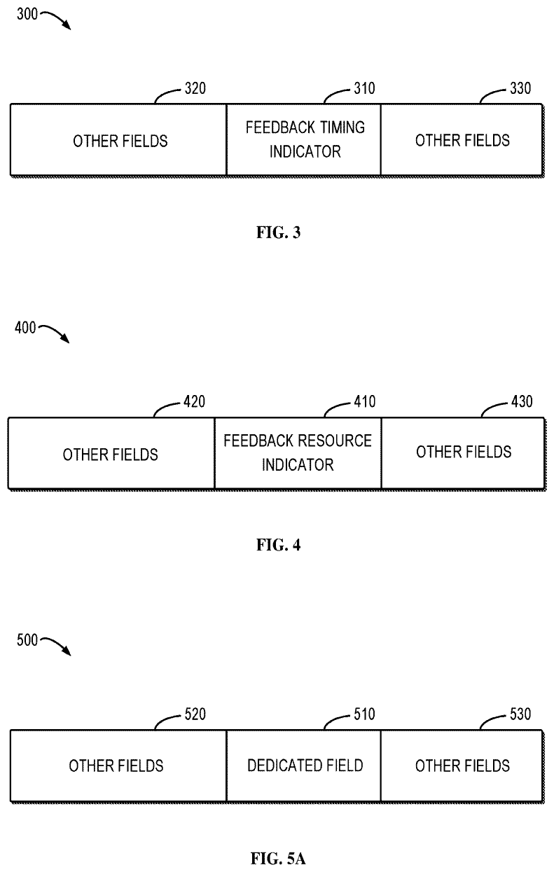

Instead of reusing the feedback timing indicator 310 to indicate the feedback configuration 105, a feedback resource indicator in the control information 115 for indicating a resource for transmitting the feedback 135 can be reused to also indicate the feedback configuration 105. In other words, the enabling or disabling of the feedback 135 can be based on a newly designed feedback resource indicator compared to a conventional feedback resource indicator only for indicating the resource for transmitting the feedback 135. In this way, both the feedback configuration 105 and the resource for transmitting the feedback 135 can be indicated by the same feedback resource indicator, thereby reducing the signaling overhead of the control information 115. Such an embodiment will be further described below with reference to FIG. 4.

FIG. 4 illustrates an example structure 400 of the control information 115 in which a feedback resource indicator 410 is reused to indicate the feedback configuration 105 in accordance with some embodiments of the present disclosure. As shown in FIG. 4, the control information 115 of the example structure 400 may include the feedback resource indicator 410, other fields 420 before the feedback resource indicator 410, and other fields 430 after the feedback resource indicator 410. It is to be appreciated that the particular position of the feedback resource indicator 410 is only for example without suggesting any limitation. In other embodiments, the feedback resource indicator 410 can be arranged at the beginning or the end of the control information 115.

In some embodiments, the control information 115 of the example structure 400 can be a DCI format as defined in the 3GPP specifications, and feedback resource indicator 410 may be the PUCCH resource indicator in the DCI format. The definitions and more details of the PUCCH resource indicator can be found in the 3GPP specifications. More generally, in some other embodiments, the feedback resource indicator 410 can be any indicator for indicating the resource for transmitting feedback either currently known or to be developed in the future.

Referring to both FIGS. 2 and 4, in order to reuse the feedback resource indicator 410 in the control information 115 to indicate the determined (210) feedback configuration 105, the network device 110 may set the feedback resource indicator 410 to indicate the feedback configuration 105 when generating (220) the control information 115. Correspondingly, upon receiving (240) the control information 115, the terminal device 120-1 can determine (250) the feedback configuration 105 based on the feedback resource indicator 410 in the control information 115.

In some embodiments, the network device 110 may implicitly indicate the feedback configuration 105 using the feedback resource indicator 410. In this way, there is no need for the network device 110 to predefine or predetermine a value of the feedback resource indicator 410 to indicate enabling or disabling of the feedback 135, thereby reducing the complexity of the implementations of the network device 110 and the terminal devices 120.

More particularly, if the network device 110 determines that the feedback 135 is to be disabled, the network device 110 may set the feedback resource indicator 410 to have a value indicating an inapplicable resource. In other words, the terminal devices 120 cannot determine an applicable resource from the feedback resource indicator 410, and thus is unable to transmit the feedback 135 to the network device 110. Therefore, the terminal devices 120 can implicitly determine that the feedback 135 is disabled by the network device 110. On the other hand, if the network device 110 determines that the feedback 135 is to be enabled, the network device 110 may alternatively set the feedback resource indicator 410 to have a value indicating an applicable resource. In other words, the terminal devices 120 can determine an applicable resource from the feedback resource indicator 410, and thus is able to transmit the feedback 135 to the network device 110. Therefore, the terminal devices 120 can implicitly determine that the feedback 135 is enabled by the network device 110.

In some embodiments, the feedback resource indicator 410 may be the PUCCH resource indicator in the DCI format as defined in the 3GPP specifications, and the shared channel transmission 125 may be an MBS PDSCH transmission. In these embodiments, a set of PUCCH resources may be configured by RRC signalling and include an inapplicable PUCCH resource for disabling the HARQ-ACK feedback. For the PUCCH resource configured for the terminal device 120-1 to transmit the HARQ-ACK feedback corresponding to the MBS PDSCH transmission, an inapplicable PUCCH resource can be configured by the network device 110 to disable the HARQ-ACK feedback for the MBS PDSCH transmission. For example, the inapplicable PUCCH resource can be configured with only the PUCCH resource index and without other parameters, or configured with inapplicable frequency domain resource information (for example, setting starting PRB index to a negative value, or setting number of PRBs to zero or a negative value) or inapplicable time domain resource information (for example, setting starting symbol index to a negative value, or setting number of symbols to zero or a negative value) or inapplicable code domain resource information (for example, setting cyclic shift index and/or OCC index to negative values). Based on such possible configurations, the terminal device 120-1 cannot identify a valid PUCCH resource for transmitting HARQ-ACK feedback.

If the network device 110 determines to disable the HARQ-ACK feedback for the MBS PDSCH transmission, the network device 110 can indicate the inapplicable PUCCH resource by setting the PUCCH resource indicator in the DCI format to the index of the inapplicable PUCCH resource in the set of PUCCH resources. If the network device 110 determines to enable the HARQ-ACK feedback for the MBS PDSCH transmission, the network device 110 can indicate an applicable PUCCH resource by setting the PUCCH resource indicator in the DCI format to the index of the applicable PUCCH resource in the set of PUCCH resources.

Table 3 as below shows an example of implicit indications of the enabling or disabling of the feedback 135 using the feedback resource indicator 410. In some embodiments, Table 3 can be configured by the network device 110 for the terminal device 120-1 via RRC signaling.

TABLE 3

| Value of feedback | | Enabling or |
|---|---|---|
| timing indicator | | disabling |
| (3 bits) | Feedback resource | of feedback |
| 000 | Inapplicable resource | Disabled |
| 001 | Applicable resource | Enabled |
| 010 | Applicable resource | Enabled |
| 011 | Applicable resource | Enabled |
| 100 | Applicable resource | Enabled |
| 101 | Applicable resource | Enabled |
| 110 | Applicable resource | Enabled |
| 111 | Applicable resource | Enabled |

In the example shown in above Table 3, it is assumed that the feedback resource indicator 410 includes 3 bits and thus can have eight values “000” to “111.” For each of the terminal devices 120 (for example the terminal device 120-1), each of the eight values can indicate a resource for the terminal device 120-1 to transmit the feedback 135 to the network device 110. It is to be understood that the particular number of bits, the particular feedback resources, and the particular mappings as shown in Table 3 are only for the purpose of illustration without suggesting any limitations. In other embodiments, the feedback resource indicator 410 can have any number of bits, any inapplicable or applicable feedback resources, and any mappings to the enabling or disabling of the feedback 135.

As shown in Table 3, in order to disable the feedback 135, the network device 110 can configure the value “000” of the feedback resource indicator 410 to indicate an inapplicable resource. That is, based on the value “000” of the feedback resource indicator 410, the terminal device 120-1 cannot determine a valid resource for transmitting the feedback 135, and thus can implicitly determine that the feedback 135 is disabled by the network device 110.

In contrast, as further shown in Table 3, in order to enable the feedback 135, the network device 110 can configure the value “001” of the feedback resource indicator 410 to indicate an applicable resource. That is, based on the value “001” of the feedback resource indicator 410, the terminal device 120-1 can determine a valid resource for transmitting the feedback 135, and thus implicitly determine that the feedback 135 is enabled by the network device 110. Similarly, by setting the values “010” to “111” to indicate different applicable resources, the network device 110 can configure values “010” to “111” to implicitly indicate to the terminal device 120-1 that the feedback 135 is enabled.

On the receiving side of the control information 115 including the feedback resource indicator 410, if the terminal device 120-1 determines that the feedback resource indicator 410 has a value indicating an inapplicable resource, the terminal device 120-1 can implicitly determine that the feedback configuration 105 indicates the disabling of the feedback 135. If the terminal device 120-1 determines that the feedback resource indicator 410 has a value indicating an applicable resource, the terminal device 120-1 can implicitly determine that the feedback configuration 105 indicates the enabling of the feedback 135.

In some embodiments, the feedback resource indicator 410 may be the PUCCH resource indicator in the DCI format as defined in the 3GPP specifications, and the shared channel transmission 125 may be an MBS PDSCH transmission. In these embodiments, upon reception of the DCI format for scheduling the MBS PDSCH, if the inapplicable PUCCH resource is indicated, then the terminal device 120-1 may not transmit the HARQ-ACK feedback corresponding to the MBS PDSCH. If one applicable PUCCH resource is indicated, then the terminal device 120-1 may transmit the HARQ-ACK feedback in the PUCCH resource.

Instead of the above described implicit way, the network device 110 may also explicitly indicate the feedback configuration 105 using the feedback resource indicator 410. As such, the enabling or disabling of the feedback 135 can be indicated and determined in a simple and direct way, thereby simplifying the operations of the network device 110 to configure the feedback resource indicator 410 to indicate the enabling or disabling of the feedback 135, and also simplifying the operations of the terminal devices 120 to determine the enabling or disabling of the feedback 135 based on the feedback resource indicator 410.

More particularly, if the network device 110 determines that the feedback 135 is to be disabled, the network device 110 may set the feedback resource indicator 410 to have a predetermined value. The predetermined value is configured for indicating the disabling of the feedback 135. On the other hand, if the network device 110 determines that the feedback 135 is to be enabled, the network device 110 may alternatively set the feedback resource indicator 410 to have a value different from the predetermined value. Values different from the predetermined value are configured for indicating the enabling of the feedback 135.

In some embodiments, the feedback resource indicator 410 may be the PUCCH resource indicator in the DCI format as defined in the 3GPP specifications, and the shared channel transmission 125 may be an MBS PDSCH transmission. In these embodiments, one code point of the PUCCH resource indicator can be reserved for indicating enabling or disabling the HARQ-ACK feedback for the MBS PDSCH. In this event, the set of PUCCH resources may not include an inapplicable PUCCH resource.

Table 4 as below shows an example of explicit indications of the enabling or disabling of the feedback 135 using the feedback resource indicator 410. In some embodiments, Table 4 can be configured by the network device 110 for the terminal device 120-1 via RRC signaling.

TABLE 4

| Value of feedback timing indicator | |
|---|---|
| (3 bits) | Enabling or disabling of feedback |
| 000 | Enabled |
| 001 | Enabled |
| 010 | Enabled |
| 011 | Enabled |
| 100 | Enabled |
| 101 | Enabled |
| 110 | Enabled |
| 111 | Disabled |

In the example shown in above Table 4, it is assumed that the feedback resource indicator 410 includes 3 bits and thus can have eight values “000” to “111.” For each of the terminal devices 120 (for example the terminal device 120-1), each of the eight values can indicate a resource for the terminal device 120-1 to transmit the feedback 135 to the network device 110. It is to be understood that the particular number of bits and the particular mappings as shown in Table 4 are only for the purpose of illustration without suggesting any limitations. In other embodiments, the feedback resource indicator 410 can have any number of bits and any mappings to the enabling or disabling of the feedback 135.

As shown in Table 4, the network device 110 can configure the value “111” to be the predetermined value for indicating disabling of the feedback 135. Accordingly, in order to disable the feedback 135, the network device 110 can configure the feedback resource indicator 410 to have the predetermined value 111. In contrast, as further shown in Table 4, in order to enable the feedback 135, the network device 110 can configure the feedback resource indicator 410 to have a value different from the predetermined value 111, for example, one of the values “000” to “110.”

On the receiving side of the control information 115 including the feedback resource indicator 410, if the terminal device 120-1 determines that the feedback resource indicator 410 has the predetermined value (for example, “111”), then the terminal device 120-1 can explicitly determine that the feedback configuration 105 indicates the disabling of the feedback 135. If the terminal device 120-1 determines that the feedback resource indicator 410 has a value (for example, one of the values “000” to “110”) different from the predetermined value, the terminal device 120-1 can explicitly determine that the feedback configuration 105 indicates the enabling of the feedback 135.

In some embodiments, the feedback resource indicator 410 may be the PUCCH resource indicator in the DCI format as defined in the 3GPP specifications, and the shared channel transmission 125 may be an MBS PDSCH transmission. In these embodiments, if a reserved code point (for example, “111”) of the PUCCH resource indicator is indicated by the DCI format, the terminal device 120-1 may determine the disabling of the HARQ-ACK feedback for the PDSCH. If a code point (for example, one of the values “000” to “110”) other than the reserved code point of the PUCCH resource indicator is indicated by the DCI format, the terminal device 120-1 may determine the enabling of the HARQ-ACK feedback for the PDSCH.

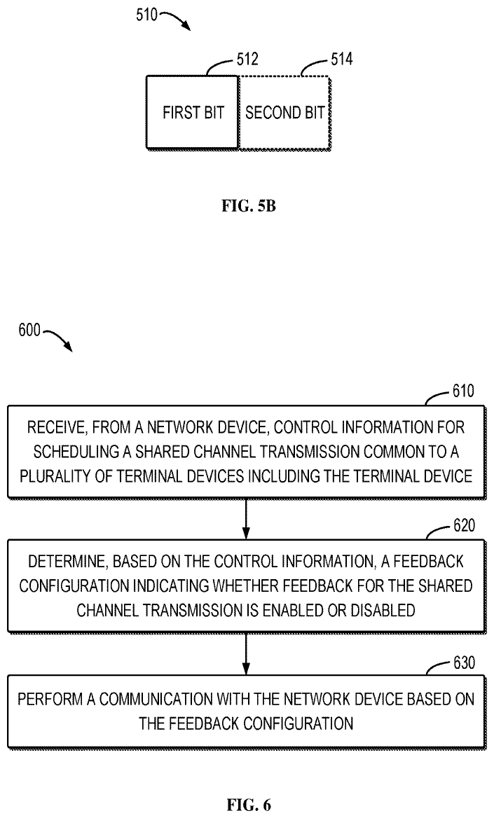

Hereinbefore, some embodiments are described in which a scheduling information field of the control information 115 is reused to indicate the feedback configuration 105. Hereinafter, some embodiments will be described with reference to FIGS. 5A and 5B in which a dedicated field of the control information 115 is used to indicate the feedback configuration 105. In other words, the dedicated field is specially designed and configured for indicating the feedback configuration 105. For example, the enabling or disabling of the feedback 135 can be based on the newly introduced field (or bits) in the control information 115. In this way, the enabling or disabling of the feedback 135 can be indicated and determined by the dedicated field in a simple and direct way, thereby simplifying the operations of the network device 110 to indicate the enabling or disabling of the feedback 135, and also simplifying the operations of the terminal devices 120 to determine the enabling or disabling of the feedback 135. Such an embodiment will be further described below with reference to FIG. 5A.

FIG. 5A illustrates an example information structure 500 of the control information 115 in which a dedicated field 510 is used to indicate the feedback configuration 105 in accordance with some embodiments of the present disclosure. As shown in FIG. 5A, the control information 115 of the example structure 500 may include the dedicated field 510, other fields 520 before the dedicated field 510, and other fields 530 after the dedicated field 510. It is to be appreciated that the particular position of the dedicated field 510 is only for example without suggesting any limitation. In other embodiments, the dedicated field 510 can be arranged at the beginning or the end of the control information 115.

Referring to both FIGS. 2 and 5A, in order to use the dedicated field 510 in the control information 115 to indicate the determined (210) feedback configuration 105, the network device 110 may set the dedicated field 510 to indicate the feedback configuration 105 when generating (220) the control information 115. Correspondingly, upon receiving (240) the control information 115, the terminal device 120-1 can determine (250) the feedback configuration 105 based on the dedicated field 510 in the control information 115.

In some embodiments, the enabling or disabling of the feedback 135 can be indicated by one bit in the dedicated field 510. In this way, the signaling overhead for indicating the enabling or disabling of the feedback 135 can be minimized. Such an embodiment will be further described below with reference to FIG. 5B.

FIG. 5B illustrates an example structure of the dedicated field 510 in accordance with some embodiments of the present disclosure. As shown in FIG. 5B, the dedicated field 510 of the example structure may include a first bit 512 for indicating whether the feedback 135 is enabled or disabled. In some embodiments, the dedicated field 510 of the example structure may also include a second bit 514 for indicating another setting of the feedback 135. It is to be appreciated that the particular position of the first bit 512 is only for example without suggesting any limitation. In other embodiments, the first bit 512 can be arranged after the second bit 514. In some further embodiments, the dedicated field 510 of the example structure may have further bits for indicating more settings of the feedback 135.

When setting the dedicated field 510 to indicate the enabling or disabling of the feedback 135, if the network device 110 determines that the feedback 135 is to be disabled, the network device 110 can set the first bit 512 in the dedicated field 510 to have a first value, for example, any one of “0” and “1.” The first value is configured for indicating the disabling of the feedback 135. On the other hand, if the network device 110 determines that the feedback 135 is to be enabled, the network device 110 can set the first bit 512 to have a second value, for example, the other one of “0” and “1.” The second value is configured for indicating the enabling of the feedback 135.

On the receiving side of the control information 115 including the dedicated field 510, if the terminal device 120-1 determines that the first bit 512 in the dedicated field 510 has the first value, the terminal device 120-1 can explicitly determine that the feedback configuration 105 indicates the disabling of the feedback 135. If the terminal device 120-1 determines that the first bit 512 has the second value, the terminal device 120-1 may explicitly determine that the feedback configuration 105 indicates the enabling of the feedback 135.

In some embodiments, the control information 115 of the example structure 500 can be a DCI format as defined in the 3GPP specifications, and the shared channel transmission 125 may be an MBS PDSCH transmission. In these embodiments, one bit in the DCI format scheduling the MBS PDSCH may be introduced for enabling or disabling the HARQ-ACK feedback for the MBS PDSCH transmission. For example, a bit “1” may indicate the terminal device 120-1 to transmit the HARQ-ACK feedback while a bit “0” can indicate the terminal device 120-1 not to transmit the HARQ-ACK feedback, or vice versa.

On the receiving side of the DCI format, the terminal device 120-1 can determine the enabling or disabling of the HARQ-ACK feedback for the PDSCH based on the bit in the DCI format. For example, upon reception of the DCI format for scheduling the MBS PDSCH, if the bit indicates that the HARQ-ACK feedback for the MBS PDSCH is disabled, then UE may not transmit the HARQ-ACK feedback. If the bit indicates that the HARQ-ACK feedback for the MBS PDSCH is enabled, then UE may transmit the HARQ-ACK feedback.

Instead of using one bit in the dedicated field 510 to indicate whether the feedback 135 is enabled or disabled, a predetermined value of the whole dedicated field 510 can be used to indicate disabling of the feedback 135. In other words, if the dedicated field 510 has the predetermined value, it means that the feedback 135 is disabled. Otherwise, if the dedicated field 510 has a value different from the predetermined value, it means that the feedback 135 is enabled. In this way, the enabling or disabling of the feedback 135 can be jointly encoded together with other feedback configuration information to be indicated by the dedicated field 510, thereby minimizing the bit overhead of the whole dedicated field 510. For example, the enabling or disabling of the feedback 135 and an indication of a feedback transmission scheme can be jointly encoded in the dedicated field 510, which will be further described hereinafter.

More particularly, if the network device 110 determines that the feedback 135 is to be disabled, then the network device 110 may set the dedicated field 510 to have the predetermined value. The predetermined value is configured for indicating the disabling of the feedback 135. On the other hand, if the network device 110 determines that the feedback 135 is to be enabled, the network device 110 can set the dedicated field 510 to have a value different from the predetermined value. Values different from the predetermined value are configured for indicating the enabling of the feedback 135.

Table 5 as below shows an example of explicit indications of the enabling or disabling of the feedback 135 using the whole dedicated field 510. In some embodiments, Table 5 can be configured by the network device 110 for the terminal device 120-1 via RRC signaling.

TABLE 5

| Dedicated field (2 bits) | Enabling or disabling of feedback |
|---|---|
| 00 | Enabled |
| 01 | Enabled |
| 10 | Enabled |
| 11 | Disabled |

In the example shown in above Table 5, it is assumed that the dedicated field 510 includes 2 bits and thus can have four values “00” to “11.” As shown in Table 5, the network device 110 can configure the value “11” to be the predetermined value for indicating disabling of the feedback 135. Accordingly, in order to disable the feedback 135, the network device 110 can configure the dedicated field 510 to have the predetermined value 11.

In contrast, as further shown in Table 5, in order to enable the feedback 135, the network device 110 can configure the dedicated field 510 to have a value different from the predetermined value 11, for example, one of the values “00” to “10.” In addition, it is noted that the various values “00” to “10” indicating the enabling of the feedback 135 can be further used to indicate other aspects of the feedback configuration 105. It is to be understood that the particular number of bits and the particular mappings as shown in Table 5 are only for the purpose of illustration without suggesting any limitations. In other embodiments, the dedicated field 510 can have any number of bits and any mappings to the enabling or disabling of the feedback 135.

On the receiving side of the control information 115 including the dedicated field 510, if the terminal device 120-1 determines that the dedicated field 510 in the control information 115 has the predetermined value (for example, “11”), the terminal device 120-1 may determine that the feedback configuration 105 indicates the disabling of the feedback 135. Alternatively, if the terminal device 120-1 determines that the dedicated field 510 in the control information 115 has a value (for example, one of the values “00” to “10”) different from the predetermined value, the terminal device 120-1 may determine that the feedback configuration 105 indicates the enabling of the feedback 135.

Hereinbefore, some embodiments are described in which the feedback configuration 105 indicates whether the feedback 135 is enabled or disabled. Hereinafter, some other embodiments will be described in which the feedback configuration 105 can also indicate other configurations of the feedback 135. For example, in the case that the feedback 135 is enabled, the feedback configuration 105 can further indicate a feedback transmission scheme for the terminal devices 120 to transmit the feedback 135 to the network device 110. For instance, the feedback transmission scheme can be the first feedback transmission scheme or the second feedback transmission scheme as described hereinbefore. More generally, the feedback transmission scheme may be any scheme for transmitting the feedback either currently known or to be developed in the future.

In some embodiments, referring back to FIG. 2, in determining (210) the feedback configuration 105, if the network device 110 determines that the feedback 135 is to be enabled, the network device 110 may further determine a feedback transmission scheme based on the number of the terminal devices 120. For example, if the number of the terminal devices 120 is relatively small, then it is better to adopt the second feedback transmission scheme, otherwise, it is better to adopt the first feedback transmission scheme. Additionally or alternatively, if the resource overhead for transmitting the feedback 135 is acceptable, then it is better to adopt the second feedback transmission scheme, otherwise, it is better to adopt the first feedback transmission scheme. Additionally or alternatively, if the reliability requirement for the shared channel transmission 125 is relatively high, then it is better to adopt the second feedback transmission scheme, otherwise, it is better to adopt the first feedback transmission scheme. As such, the network device 110 can flexibly adjust the feedback transmission schemes based on the number of the terminal device 120 (for example, UEs in connected mode) or other possible factors, so as to reach a good tradeoff between transmission reliability and resource overhead.

After determining the feedback transmission scheme, the network device 110 can configure the feedback configuration 105 to indicate the feedback transmission scheme. As such, the enabling or disabling of the feedback 135 and the feedback transmission scheme can be collectively indicated in the feedback configuration 105, and simplifying the indicating of a plurality of feedback settings of the feedback 135 in the feedback configuration 105 and also the determining of the plurality of feedback settings of the feedback 135 in the feedback configuration 105.

There may be various manners for the network device 110 to indicate the feedback transmission scheme in the control information 115. For example, the feedback timing indicator 310, the feedback resource indicator 410 or the dedicated field 510 in the control information 115 can be used to indicate the feedback transmission scheme. Accordingly, upon receiving the control information 115, the terminal device 120-1 can determine the feedback transmission scheme from the control information 115 in different manners corresponding to the various manners in which the network device 110 indicates the feedback transmission scheme in the control information 115. Some embodiments of different manners for the network device 110 to indicate the feedback transmission scheme in the control information 115 and the corresponding manners for the terminal device 120-1 to determine the feedback transmission scheme from the control information 115 will be further described hereinafter with reference to FIGS. 3-5.

Continuing with reference to FIG. 2, in some embodiments, in performing (260) the communication based on the feedback configuration 105, if the terminal device 120-1 determines that the feedback configuration 105 indicates enabling of the feedback 135, the terminal device 120-1 can further determine the feedback transmission scheme indicated by the feedback configuration 105. Then, the terminal device 120-1 may transmit the feedback 135 to the network device 110 based on the feedback transmission scheme. As such, the terminal device 120-1 can transmit the feedback 135 in the way indicated by the network device 110, thereby achieving fine tradeoff between transmission reliability and resource overhead.

In some embodiments, the feedback transmission scheme indicated by the feedback configuration 105 may be the first feedback transmission scheme, for example, the group NACK transmission scheme. Then, the terminal device 120-1 may transmit the feedback 135 to the network device 110 according to the group NACK transmission scheme. For example, if the terminal device 120-1 unsuccessfully receives the shared channel transmission 125, the terminal device 120-1 may transmit negative feedback (for example, a NACK) to the network device 110 using a resource common to the terminal devices 120. On the other hand, if the terminal device 120-1 successfully receives the shared channel transmission 125, the terminal device 120-1 may not transmit feedback 135 (for example, an ACK) to the network device 110. In this way, the terminal device 120-1 can only transmit a negative feedback using a common resource if the reception of the shared channel transmission 125 is unsuccessful, and the transmissions of a positive feedback can be avoided, thereby reducing the resource overhead for transmitting the feedback 135.

In some embodiments, the feedback transmission scheme indicated by the feedback configuration 105 may be the second feedback transmission scheme, for example, the UE-specific ACK/NACK transmission scheme. Then, the terminal device 120-1 may transmit the feedback 135 to the network device 110 according to the UE-specific ACK/NACK transmission scheme. For example, if the terminal device 120-1 successfully receives the shared channel transmission 125, the terminal device 120-1 can transmit positive feedback (for example, an ACK) to the network device 110 using a resource specific to the terminal device 120-1. If the terminal device 120-1 unsuccessfully receives the shared channel transmission 125, the terminal device 120-1 may transmit negative feedback (for example, a NACK) to the network device 110 using the resource specific to the terminal device 120-1. In this way, the reliability of the shared channel transmission 125 can be maximized.

As mentioned above, there may be various manners for the network device 110 to indicate the feedback transmission scheme in the control information 115. Accordingly, the terminal device 120-1 can determine the feedback transmission scheme from the control information 115 in different manners corresponding to the various manners in which the network device 110 indicates the feedback configuration 105 in the control information 115. Such embodiments will be further described hereinafter with reference to FIGS. 3-5.

As an example manner for indicating the feedback transmission scheme, referring back to FIG. 3, the control information 115 has the example information structure 300, and the feedback configuration 105 is to be indicated by the feedback timing indicator 310 in the control information 115. Therefore, the feedback timing indicator 310 in the control information 115 can be reused to also indicate the feedback transmission scheme. In other words, the dynamic switching among different feedback transmission schemes can be based on a newly designed feedback timing indicator compared to a conventional feedback timing indicator only for indicating the timing of the feedback 135.

In this event, in order to configure the feedback configuration 105 (which is indicated by the feedback timing indicator 310) to indicate a feedback transmission scheme, the network device 110 can configure predetermined associations between indexes of the feedback timing values and feedback transmission schemes. In this way, each of the indexes of the feedback timing values can indicate both a feedback timing value and a corresponding feedback transmission scheme, and thus a dedicated indication for the feedback transmission scheme can be avoided, thereby reducing signaling overhead of the control information 115. Table 6 as below shows an example of such associations between the indexes of the feedback timing values and feedback transmission schemes. In some embodiments, Table 6 can be configured by the network device 110 for the terminal device 120-1 via RRC signaling.

TABLE 6

| Value of feedback | | | |
|---|---|---|---|
| timing indicator | | | Feedback |
| (3 bits) | Index | Feedback timing value | transmission scheme |
| 000 | 0 | Inapplicable timing | N/A |
| | | value | |
| 001 | 1 | Applicable timing | First feedback |
| | | value | transmission scheme |
| 010 | 2 | Applicable timing | First feedback |
| | | value | transmission scheme |
| 011 | 3 | Applicable timing | Second feedback |
| | | value | transmission scheme |
| 100 | 4 | Applicable timing | First feedback |
| | | value | transmission scheme |
| 101 | 5 | Applicable timing | Second feedback |
| | | value | transmission scheme |
| 110 | 6 | Applicable timing | First feedback |
| | | value | transmission scheme |
| 111 | 7 | Applicable timing | Second feedback |
| | | value | transmission scheme |

In the example of above Table 6, it is assumed that the feedback timing indicator 310 includes 3 bits and thus can have eight values “000” to “111.” The different values of the feedback timing indicator 310 can be mapped to various indexes of different feedback timing values. As shown in Table 6, an index of each applicable timing value is associated with a feedback transmission scheme. For example, each numerical HARQ-ACK feedback timing value included in the set of HARQ-ACK feedback timing values is associated with a HARQ-ACK feedback option. In this way, the network device 110 can explicitly indicate a feedback transmission scheme by setting the value of the feedback timing indicator 310 to indicate a corresponding index of the applicable timing value.

For example, according to Table 6, the network device 110 may determine an index of a feedback timing value based on a predetermined association between the index of the feedback timing value and the feedback transmission scheme. Then, the network device 110 can set the feedback timing indicator 310 to indicate the index of the feedback timing value. In some embodiments, the feedback timing indicator 310 can be the PDSCH-to-HARQ_feedback timing indicator in DCI format as defined in the 3GPP specifications, and the shared channel transmission 125 may be an MBS PDSCH transmission. In these embodiments, in order to dynamically indicate either Option 1 or Option 2 for the HARQ-ACK feedback for the MBS PDSCH transmission, the set of HARQ-ACK feedback timing values can be configured with additional information on Option 1 or Option 2 to the terminal device 120-1.

On the receiving side of the control information 115, the terminal device 120-1 can determine the feedback configuration 105 based on the feedback timing indicator 310 in the control information 115, and the feedback configuration 105 indicates enabling of the feedback 135. In this event, the terminal device 120-1 can determine an index of a feedback timing value from the feedback timing indicator 310. Then, the terminal device 120-1 may determine the feedback transmission scheme based on the predetermined association between the index of the feedback timing value and the feedback transmission scheme. For example, in above Table 6, if the terminal device 120-1 determines that the feedback timing indicator 310 indicates the index 4 of the feedback timing value, then the terminal device 120-1 can determine that the feedback transmission scheme is the first feedback transmission scheme.

In some embodiments, the feedback timing indicator 310 can be the PDSCH-to-HARQ_feedback timing indicator in DCI format as defined in the 3GPP specifications, and the shared channel transmission 125 may be an MBS PDSCH transmission. In these embodiments, a HARQ-ACK feedback option can be determined based on the HARQ-ACK feedback option associated with a numerical HARQ-ACK feedback timing value indicated by the DCI format. More particularly, upon reception of one DCI format for scheduling the MBS PDSCH, if one numerical value is indicated by the PDSCH-to-HARQ_feedback timing indicator in the DCI format, then the terminal device 120 may adopt the HARQ-ACK feedback option associated with the numerical value and transmit the HARQ-ACK based on the indicated option in the slot with an offset of the indicated numerical value to the slot where the DCI format is received.

It is to be understood that the particular number of bits, the particular feedback timing values, the particular indexes, and the particular mappings as shown in Table 6 are only for the purpose of illustration without suggesting any limitations. In other embodiments, the feedback timing indicator 310 can have any number of bits, any inapplicable or applicable feedback timing values, any indexes, and any mappings to the enabling or disabling of the feedback 135. In addition, it is noted that there can be a same applicable timing value having different indexes mapping to different feedback transmission schemes. For example, in above Table 6, the indexes 2 and 3 can both be mapped to the applicable timing value “+2,” but be mapped to different feedback transmission schemes. Similarly, the indexes 4 and 5 can both be mapped to the applicable timing value “+3,” but be mapped to different feedback transmission schemes. Further, the indexes 6 and 7 can both be mapped to the applicable timing value “+4,” but be mapped to different feedback transmission schemes.

As another example manner for indicating the feedback transmission scheme, referring back to FIG. 4, the control information 115 has the example information structure 400, and the feedback configuration 105 is to be indicated by the feedback resource indicator 410 in the control information 115. Therefore, the feedback resource indicator 410 in the control information 115 can be reused to also indicate the feedback transmission scheme. In other words, the dynamic switching among different feedback transmission schemes can be based on a newly designed feedback resource indicator compared to a conventional feedback resource indicator only for indicating the resource for transmitting the feedback 135.

In this event, in order to configure the feedback configuration 105 (which is indicated by the feedback resource indicator 410) to indicate a feedback transmission scheme, the network device 110 can configure predetermined associations between indexes of the feedback resources and feedback transmission schemes. In this way, each of the indexes of the feedback resources can indicate both a feedback resource and a corresponding feedback transmission scheme, and thus a dedicated indication for the feedback transmission scheme can be avoided, thereby reducing signaling overhead of the control information 115. Table 7 as below shows an example of such associations between the indexes of the feedback resources and feedback transmission schemes. In some embodiments, Table 7 can be configured by the network device 110 for the terminal device 120-1 via RRC signaling.

TABLE 7

| Value of feedback | | | |
|---|---|---|---|
| timing indicator | | | Feedback |
| (3 bits) | index | Feedback resource | transmission scheme |
| 000 | 0 | Inapplicable resource | N/A |
| 001 | 1 | Applicable resource | First feedback |
| | | | transmission scheme |
| 010 | 2 | Applicable resource | First feedback |
| | | | transmission scheme |
| 011 | 3 | Applicable resource | Second feedback |
| | | | transmission scheme |
| 100 | 4 | Applicable resource | First feedback |
| | | | transmission scheme |
| 101 | 5 | Applicable resource | Second feedback |
| | | | transmission scheme |
| 110 | 6 | Applicable resource | First feedback |
| | | | transmission scheme |
| 111 | 7 | Applicable resource | Second feedback |
| | | | transmission scheme |

In the example of above Table 7, it is assumed that the feedback resource indicator 410 includes 3 bits and thus can have eight values “000” to “111.” The different values of the feedback resource indicator 410 can be mapped to various indexes of different feedback resources. As shown in Table 7, an index of each applicable resource is associated with a feedback transmission scheme. For example, each applicable PUCCH resource in the set of PUCCH resources is configured with an associated HARQ-ACK feedback option. In this way, the network device 110 can explicitly indicate a feedback transmission scheme by setting the value of the feedback resource indicator 410 to indicate a corresponding index of applicable feedback resource.

For example, according to Table 7, the network device 110 may determine an index of a feedback resource based on a predetermined association between the index of the feedback resource and the feedback transmission scheme. Then, the network device 110 can set the feedback resource indicator 410 to indicate the index of the feedback resource. In some embodiments, the feedback resource indicator 410 can be the PUCCH resource indicator in DCI format as defined in the 3GPP specifications, and the shared channel transmission 125 may be an MBS PDSCH transmission. In these embodiments, in order to dynamically indicate either Option 1 or Option 2 for HARQ-ACK feedback for the MBS PDSCH transmission, each of the set of applicable PUCCH resources can be configured with additional information on Option 1 or Option 2 to the terminal device 120-1. For example, an element on either Option 1 or Option 2 can be included in the RRC configured PUCCH resource.

On the receiving side of the control information 115, the terminal device 120-1 can determine the feedback configuration 105 based on the feedback resource indicator 410 in the control information 115, and the feedback configuration 105 indicates enabling of the feedback 135. In this event, the terminal device 120-1 may determine an index of a resource for the feedback 135 from the feedback resource indicator 410. Then, the terminal device 120-1 may determine the feedback transmission scheme based on a predetermined association between the index of the resource and the feedback transmission scheme. For example, in above Table 7, if the terminal device 120-1 determines that the feedback resource indicator 410 indicates the index 4 of the feedback resource, then the terminal device 120-1 can determine that the feedback transmission scheme is the first feedback transmission scheme.

In some embodiments, the feedback resource indicator 410 can be the PUCCH resource indicator in DCI format as defined in the 3GPP specifications, and the shared channel transmission 125 may be an MBS PDSCH transmission. In these embodiments, a HARQ-ACK feedback option may be determined based on the HARQ-ACK feedback option associated with the applicable PUCCH resource indicated by the DCI format. More particularly, upon reception of the DCI for scheduling MBS PDSCH, if one applicable PUCCH resource is indicated, then the terminal device 120-1 can adopt the HARQ-ACK feedback option specified in the applicable PUCCH resource.

It is to be understood that the particular number of bits, the particular feedback resources, the particular indexes, and the particular mappings as shown in Table 7 are only for the purpose of illustration without suggesting any limitations. In other embodiments, the feedback resource indicator 410 can have any number of bits, any inapplicable or applicable feedback resources, any indexes, and any mappings to the enabling or disabling of the feedback 135. In addition, it is noted that there can be a same applicable resource having different indexes mapping to different feedback transmission schemes.

Instead of the above explicit manner for the feedback resource indicator 410 to indicate a feedback transmission scheme, the feedback resource indicator 410 may indicate a feedback transmission scheme in an implicit manner. Particularly, in some embodiments, the terminal devices 120 use a common resource to transmit the feedback 135 in the first feedback transmission scheme, whereas the terminal devices 120 use respective UE-specific resources to transmit the feedback 135 in the second feedback transmission scheme. For example, the first feedback transmission scheme may be the group NACK transmission scheme (namely Option 1) and the second feedback transmission scheme may be the UE-specific ACK/NACK transmission scheme (namely Option 2).

For Option 1, a group-common PUCCH resource for NACK only transmission is configured to a group of UEs via UE dedicated RRC signaling and shared by the group of UEs. Since each PUCCH resource is defined with a unique PUCCH resource index, such group-common PUCCH resource is defined with a same index for each UE of the group. For example, when configuring the group-common PUCCH resource to each UE, the gNB configures same index 0 for the resource to each UE. For Option 2, the UE-specific PUCCH resource for either ACK or NACK transmission is configured via UE dedicated RRC signaling. For one UE, the PUCCH resource index for Option 2 can be defined same or different to PUCCH resource index of other UEs in same group.

In these embodiments, it can be seen that the first and second feedback transmission schemes can be distinguished by whether a common resource is to be used by the terminal devices 120. In this event, in order to configure the feedback configuration 105 (which is indicated by the feedback resource indicator 410) to indicate the first feedback transmission scheme, the network device 110 can configure the feedback resource indicator 410 to indicate a common resource for the terminal devices 120 to transmit the feedback 135. In order to configure the feedback configuration 105 (which is indicated by the feedback resource indicator 410) to indicate the second feedback transmission scheme, the network device 110 can configure the feedback resource indicator 410 to indicate a resource other than the common resource. In this way, one of the first and second feedback transmission schemes can be implicitly by the feedback resource indicator 410, and thus a dedicated indication for the feedback transmission scheme can be avoided, thereby reducing signaling overhead of the control information 115. Table 8 as below shows an example of such implicit indications of the feedback transmission schemes using the feedback resource indicator. In some embodiments, Table 8 can be configured by the network device 110 for the terminal device 120-1 via RRC signaling.

TABLE 8

| Value of feedback | | |
|---|---|---|
| timing indicator | | Feedback |
| (3 bits) | Feedback resource | transmission scheme |
| 000 | Common resource | First feedback |
| | | transmission scheme |
| 001 | UE-Specific resource | Second feedback |
| | | transmission scheme |
| 010 | UE-Specific resource | Second feedback |
| | | transmission scheme |
| 011 | UE-Specific resource | Second feedback |
| | | transmission scheme |
| 100 | UE-Specific resource | Second feedback |
| | | transmission scheme |
| 101 | UE-Specific resource | Second feedback |
| | | transmission scheme |
| 110 | UE-Specific resource | Second feedback |
| | | transmission scheme |
| 111 | UE-Specific resource | Second feedback |
| | | transmission scheme |

In the example of above Table 8, it is assumed that the feedback resource indicator 410 includes 3 bits and thus can have eight values “000” to “111.” As shown in Table 8, the different values of the feedback resource indicator 410 can be mapped to a common resource or a UE-specific resource. The common resource implicitly indicates the first feedback transmission scheme and the UE-specific resources indicate the second feedback transmission scheme. In the embodiments of the MBS service in 5G NR, the set of PUCCH resources may include a common PUCCH resource configured with a same index among the respective set of PUCCH resources of each UE of the plurality of UEs and shared by the plurality of UEs. In this way, the network device 110 can implicitly indicate a feedback transmission scheme by setting the value of the feedback resource indicator 410 to indicate a common resource or a UE-specific resource. For example, according to Table 8, the network device 110 may set the feedback resource indicator 410 to indicate a common resource for the terminal devices 120 based on the feedback transmission scheme, more particularly, if the feedback transmission scheme is the first feedback transmission.

On the receiving side of the control information 115, the terminal device 120-1 may determine the feedback configuration 105 based on the feedback resource indicator 410 in the control information 115, and the feedback configuration 105 indicates enabling of the feedback 135. In this event, the terminal device 120-1 can determine whether the feedback resource indicator 410 indicates a common resource for the terminal devices 120 to transmit the feedback 135 for the shared channel transmission 125. Then, the terminal device 120-1 may determine the feedback transmission scheme based on a result of the determination. For example, in above Table 8, if the terminal device 120-1 determines that the feedback resource indicator 410 indicates a common resource, then the terminal device 120-1 can determine that the feedback transmission scheme is the first feedback transmission scheme. Otherwise, if the terminal device 120-1 determines that the feedback resource indicator 410 indicates a UE-specific resource, then the terminal device 120-1 can determine that the feedback transmission scheme is the second feedback transmission scheme.

In some embodiments, the feedback resource indicator 410 can be the PUCCH resource indicator in DCI format as defined in the 3GPP specifications, and the shared channel transmission 125 may be an MBS PDSCH transmission. In these embodiments, if the common PUCCH resource is indicated by the DCI format, the terminal device 120-1 may determine to adopt Option 1. If an applicable PUCCH resource other than the common PUCCH resource is indicated by the DCI format, the terminal device 120-1 may determine to adopt Option 2.

More particularly, if the PUCCH resource indicator in the DCI format scheduling the MBS PDSCH indicates an index of the group-common PUCCH resource, for example, index of 0, then it implies to the terminal devices 120 that HARQ-ACK feedback Option 1 is to be adopted, and then each of the terminal devices 120 may transmit a NACK in the PUCCH resource 0 if the MBS PDSCH is not successfully decoded by the terminal device. Otherwise, the terminal device does not transmit anything in the PUCCH resource 0 if the MBS PDSCH is successfully decoded by the terminal device. If the PUCCH resource indicator in the DCI format scheduling the MBS PDSCH indicates a PUCCH resource index other than PUCCH resource 0, then it implies to the terminal devices 120 that HARQ-ACK feedback Option 2 is adopted, and then each terminal device may transmit respective ACK or NACK corresponding to the MBS PDSCH in the set of UE-specific PUCCH resources indicated by the PUCCH resource index.

It is to be understood that the particular number of bits, the particular feedback resources, and the particular mappings as shown in Table 8 are only for the purpose of illustration without suggesting any limitations. In other embodiments, the feedback resource indicator 410 can have any number of bits, any common or UE-specific feedback resources, and any mappings to the enabling or disabling of the feedback 135.

As a further example manner for indicating the feedback transmission scheme, referring back to FIG. 5A, the control information 115 has the example information structure 500, and the feedback configuration 105 is to be indicated by the dedicated field 510 in the control information 115. Therefore, the dedicated field 510 in the control information 115 can be used to also indicate the feedback transmission scheme. In other words, the dynamic switching among different feedback transmission schemes can be based on newly introduced field (or bits) in the control information 115 compared to a conventional DCI for scheduling the shared channel transmission 125.

For example, referring back to FIG. 5B, the first bit 512 in the dedicated field 510 in the control information 115 indicates whether the feedback 135 is enabled or disabled. In this event, in order to configure the feedback configuration 105 (which is indicated by the dedicated field 510) to indicate a feedback transmission scheme, the network device 110 can set a second bit 514 in the dedicated field 510 to indicate the feedback transmission scheme. In this way, the signaling overhead for indicating one of two feedback transmission schemes can be minimized. For example, one of the values “0” and “1” of the second bit 514 can be used to indicate the first feedback transmission scheme, and the other of the values “0” and “1” of the second bit 514 can be used to indicate the second feedback transmission scheme. It is to be understood that if more than two feedback transmission schemes are available, the second bit 514 can be extended to have more than one bit for indicating a particular feedback transmission scheme from three or more feedback transmission schemes.

In some embodiments, the control information 115 can be the DCI format as defined in the 3GPP specifications, and the shared channel transmission 125 may be an MBS PDSCH transmission. In these embodiments, in order to dynamically indicate either Option 1 or Option 2 for HARQ-ACK feedback for the MBS PDSCH transmission, one bit is introduced to indicate the enabling or disabling of the HARQ-ACK feedback, and another bit in the DCI scheduling the MBS PDSCH is introduced for indicating the HARQ-ACK feedback Option 1 or Option 2 for the MBS PDSCH. For example, bit “0” indicates the terminal devices 120 to adopt the HARQ-ACK feedback Option 1, while bit “1” indicates the terminal devices 120 to adopt the HARQ-ACK feedback Option 2, or vice versa.

On the receiving side of the control information 115, the terminal device 120-1 can determine whether the feedback is enabled or disabled based on the first bit 512 in the dedicated field 510 in the control information 115. In this event, the terminal device 120-1 may determine the feedback transmission scheme based on the second bit 514 in the dedicated field 510. In some embodiments, the control information 115 can be the DCI format as defined in the 3GPP specifications, and the shared channel transmission 125 may be an MBS PDSCH transmission. In these embodiments, the terminal device 120-1 may determine a HARQ-ACK feedback option based on a second bit in the DCI format. Upon reception of the DCI format for scheduling the MBS PDSCH, if the HARQ-ACK feedback for the MBS PDSCH is enabled, then the terminal devices 120 may further check the bit for indicating Option 1 or Option 2 for transmitting the corresponding HARQ-ACK feedback.

In some embodiments, instead of being separately indicated in the dedicated field 510, the first bit 512 and the second bit 514 in the dedicated field 510 as shown in FIG. 5B can be jointly encoded as different values of the whole dedicated field 510 in the control information 115. In this way, the indication of one of the first and second feedback transmission schemes can be jointly encoded together with the enabling or disabling of the feedback 135 using the whole dedicated field 510, thereby minimizing the bit overhead of the whole dedicated field 510. Table 9 as below shows an example of explicit indications of the feedback transmission schemes using the whole dedicated field 510. In some embodiments, Table 9 can be configured by the network device 110 for the terminal device 120-1 via RRC signaling.

TABLE 9

| Dedicated field (2 bits) | Feedback configuration |
|---|---|
| 00 | First feedback transmission scheme |
| 01 | Second feedback transmission scheme |
| 10 | Feedback Disabled |
| 11 | Reserved |

In the example of above Table 9, it is assumed that the dedicated field 510 includes 2 bits and thus can have four values “00” to “11.” As shown in Table 9, the different values of the dedicated field 510 can be mapped to different configurations of the feedback 135. For example, the first value “00” of the dedicated field 510 may indicate the first feedback transmission scheme, the second value “01” of the dedicated field 510 may indicate the second feedback transmission scheme, the third value “10” of the dedicated field 510 may indicate the disabling of the feedback 135, and the fourth value “11” can be reserved. In this way, the network device 110 can explicitly indicate a feedback transmission scheme by setting the value of the dedicated field 510.

For example, according to Table 9, the network device 110 may indicate the disabling of the feedback 135 by a predetermined value (for example, “10”) of the dedicated field 510 in the control information 115. Also, the network device 110 may set a value (for example, “00” or “01”) of the dedicated field 510 different from the predetermined value to indicate the feedback transmission scheme. On the receiving side of the control information 115, it is assumed that the predetermined value (for example, “10”) of the dedicated field 510 in the control information 115 indicates that the feedback 135 is disabled. Then, the terminal device 120-1 can determine the feedback transmission scheme based on a value (for example, “00” or “01”) of the dedicated field 510 different from the predetermined value.

It is to be understood that the particular number of bits and the particular mappings as shown in Table 9 are only for the purpose of illustration without suggesting any limitations. In other embodiments, the dedicated field 510 can have any number of bits and any mappings to the different configurations of the feedback 135.

### Example Method

FIG. 6 illustrates a flowchart of an example method 600 for communication in accordance with some embodiments of the present disclosure. In some embodiments, the example method 600 can be implemented at a device in a communication network, such as the terminal device 120-1 as shown in FIGS. 1A to 1C. Additionally or alternatively, the example method 600 can be implemented at other devices shown in FIGS. 1A to 1C. In some other embodiments, the example method 600 may be implemented at devices not shown in FIG. 1. Further, it is to be understood that the example method 600 may include additional blocks not shown and/or may omit some blocks as shown, and the scope of the present disclosure is not limited in this regard. For the purpose of discussion, the example method 600 will be described from the perspective of the terminal device 120-1 with reference to FIGS. 1A to 1C.

At block 610, the terminal device 120-1 receives, from the network device 110, control information for scheduling a shared channel transmission common to the plurality of terminal devices 120 including the terminal device 120-1. At block 620, the terminal device 120-1 determines, based on the control information, a feedback configuration indicating whether feedback for the shared channel transmission is enabled or disabled. At block 630, the terminal device 120-1 performs a communication with the network device 110 based on the feedback configuration.

In some embodiments, the terminal device 120-1 may determine the feedback configuration based on a feedback timing indicator in the control information.

In some embodiments, when determining the feedback configuration based on the feedback timing indicator, if the feedback timing indicator has a value indicating an inapplicable feedback timing value, the terminal device 120-1 may determine that the feedback configuration indicates that the feedback is disabled. On the other hand, if the feedback timing indicator has a value indicating an applicable feedback timing value, the terminal device 120-1 may determine that the feedback configuration indicates that the feedback is enabled.

In some embodiments, when determining the feedback configuration based on the feedback timing indicator, if the feedback timing indicator has a predetermined value, the terminal device 120-1 may determine that the feedback configuration indicates that the feedback is disabled. On the other hand, if the feedback timing indicator has a value different from the predetermined value, the terminal device 120-1 may determine that the feedback configuration indicates that the feedback is enabled.

In some embodiments, when determining the feedback configuration, the terminal device 120-1 may determine the feedback configuration based on a feedback resource indicator in the control information.

In some embodiments, when determining the feedback configuration based on the feedback resource indicator, if the feedback resource indicator has a value indicating an inapplicable resource, the terminal device 120-1 can determine that the feedback configuration indicates that the feedback is disabled. On the other hand, if the feedback resource indicator has a value indicating an applicable resource, the terminal device 120-1 can determine that the feedback configuration indicates that the feedback is enabled.

In some embodiments, when determining the feedback configuration based on the feedback resource indicator, if the feedback resource indicator has a predetermined value, the terminal device 120-1 can determine that the feedback configuration indicates that the feedback is disabled. On the other hand, if the feedback resource indicator has a value different from the predetermined value, the terminal device 120-1 can determine that the feedback configuration indicates that the feedback is enabled.

In some embodiments, when determining the feedback configuration, the terminal device 120-1 may determine the feedback configuration based on a dedicated field in the control information.

In some embodiments, when determining the feedback configuration based on the dedicated field, if a first bit in the dedicated field has a first value, the terminal device 120-1 may determine that the feedback configuration indicates that the feedback is disabled. On the other hand, if the first bit has a second value, the terminal device 120-1 may determine that the feedback configuration indicates that the feedback is enabled.

In some embodiments, when determining the feedback configuration based on the dedicated field, if the dedicated field has a predetermined value, the terminal device 120-1 may determine that the feedback configuration indicates that the feedback is disabled. On the other hand, if the dedicated field has a value different from the predetermined value, the terminal device 120-1 can determine that the feedback configuration indicates that the feedback is enabled.

In some embodiments, when performing the communication based on the feedback configuration, if the feedback configuration indicates that the feedback is disabled, the terminal device 120-1 may receive the shared channel transmission without transmitting the feedback to the network device 110.

In some embodiments, when performing the communication based on the feedback configuration, if the feedback configuration indicates that the feedback is enabled, the terminal device 120-1 can determine a feedback transmission scheme indicated by the feedback configuration, and may transmit the feedback to the network device 110 based on the feedback transmission scheme.

In some embodiments, the feedback configuration is determined based on a feedback timing indicator in the control information, and when the terminal device 120-1 determines the feedback transmission scheme, the terminal device 120-1 may determine, from the feedback timing indicator, an index of a feedback timing value, and may determine the feedback transmission scheme based on a predetermined association between the index of the feedback timing value and the feedback transmission scheme.

In some embodiments, the feedback configuration is determined based on a feedback resource indicator in the control information, and when the terminal device 120-1 determines the feedback transmission scheme, the terminal device 120-1 may determine, from the feedback resource indicator, an index of a resource for the feedback, and may determine the feedback transmission scheme based on a predetermined association between the index of the resource and the feedback transmission scheme.

In some embodiments, the feedback configuration is determined based on a feedback resource indicator in the control information, and when the terminal device 120-1 determines the feedback transmission scheme, the terminal device 120-1 can determine whether the feedback resource indicator indicates a common resource for the plurality of terminal devices 120 to transmit feedback for the shared channel transmission, and can determine the feedback transmission scheme based on a result of the determination.

In some embodiments, a first bit in a dedicated field in the control information indicates whether the feedback is enabled or disabled, and when the terminal device 120-1 determines the feedback transmission scheme, the terminal device 120-1 can determine the feedback transmission scheme based on a second bit in the dedicated field.

In some embodiments, a predetermined value of a dedicated field in the control information indicates that the feedback is disabled, and when the terminal device 120-1 determines the feedback transmission scheme, the terminal device 120-1 can determine the feedback transmission scheme based on a value of the dedicated field different from the predetermined value.

In some embodiments, when transmitting the feedback to the network device 110, if the shared channel transmission is unsuccessfully received by the terminal device 120-1, the terminal device 120-1 may transmit negative feedback to the network device 110 using a resource common to the plurality of terminal devices 120.

In some embodiments, when transmitting the feedback to the network device 110, if the shared channel transmission is successfully received by the terminal device 120-1, the terminal device 120-1 may transmit positive feedback to the network device 110 using a resource specific to the terminal device 120-1. On the other hand, if the shared channel transmission is unsuccessfully received by the terminal device 120-1, the terminal device 120-1 can transmit negative feedback to the network device 110 using the resource specific to the terminal device 120-1.

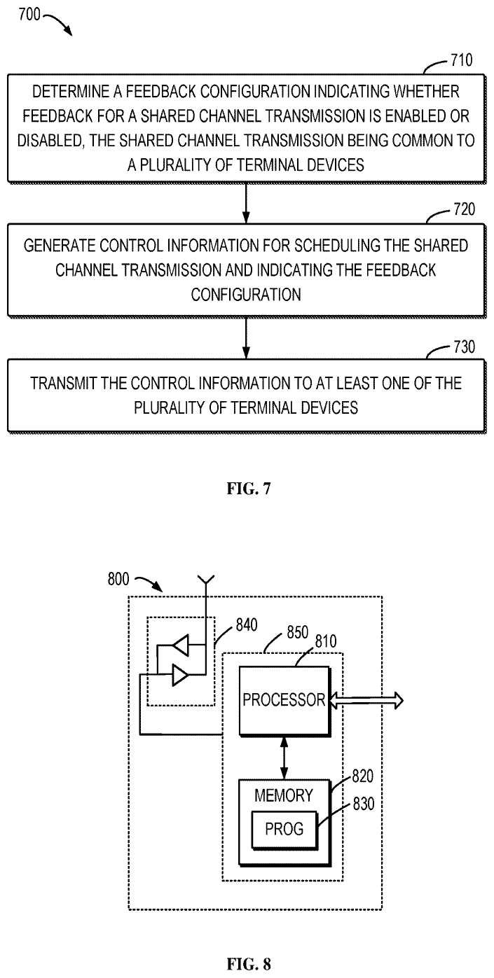

FIG. 7 illustrates a flowchart of another example method 700 for communication in accordance with some embodiments of the present disclosure. In some embodiments, the example method 700 can be implemented at a device in a communication network, such as the network device 110 as shown in FIGS. 1A to 1C. Additionally or alternatively, the example method 700 can be implemented at other devices shown in FIGS. 1A to 1C. In some other embodiments, the example method 700 may be implemented at devices not shown in FIG. 1. Further, it is to be understood that the example method 700 may include additional blocks not shown and/or may omit some blocks as shown, and the scope of the present disclosure is not limited in this regard. For the purpose of discussion, the example method 700 will be described from the perspective of the network device 110 with reference to FIGS. 1A to 1C.

At block 710, the network device 110 determines a feedback configuration indicating whether feedback for a shared channel transmission is enabled or disabled, the shared channel transmission being common to the plurality of terminal devices 120. At block 720, the network device 110 generates control information for scheduling the shared channel transmission and indicating the feedback configuration. At block 730, the network device 110 transmits the control information to at least one of the plurality of terminal devices 120.

In some embodiments, when generating the control information, the network device 110 may set a feedback timing indicator in the control information to indicate the feedback configuration.

In some embodiments, when setting the feedback timing indicator, if the feedback is to be disabled, the network device 110 may set the feedback timing indicator to have a value indicating an inapplicable feedback timing value. On the other hand, if the feedback is to be enabled, the network device 110 may set the feedback timing indicator to have a value indicating an applicable feedback timing value.

In some embodiments, when setting the feedback timing indicator, if the feedback is to be disabled, the network device 110 can set the feedback timing indicator to have a predetermined value. On the other hand, if the feedback is to be enabled, the network device 110 can set the feedback timing indicator to have a value different from the predetermined value.

In some embodiments, when generating the control information, the network device 110 can set a feedback resource indicator in the control information to indicate the feedback configuration.

In some embodiments, when setting the feedback resource indicator, if the feedback is to be disabled, the network device 110 can set the feedback resource indicator to have a value indicating an inapplicable resource. On the other hand, if the feedback is to be enabled, the network device 110 can set the feedback resource indicator to have a value indicating an applicable resource.

In some embodiments, when setting the feedback resource indicator, if the feedback is to be disabled, the network device 110 may set the feedback resource indicator to have a predetermined value. On the other hand, if the feedback is to be enabled, the network device 110 may set the feedback resource indicator to have a value different from the predetermined value.

In some embodiments, when generating the control information, the network device 110 may set a dedicated field in the control information to indicate the feedback configuration.

In some embodiments, when setting the dedicated field, if the feedback is to be disabled, the network device 110 can set a first bit in the dedicated field to have a first value. On the other hand, if the feedback is to be enabled, the network device 110 can set the first bit to have a second value.

In some embodiments, when setting the dedicated field, if the feedback is to be disabled, the network device 110 may set the dedicated field to have a predetermined value. On the other hand, if the feedback is to be enabled, the network device 110 may set the dedicated field to have a value different from the predetermined value.

In some embodiments, when determining the feedback configuration, the network device 110 can determine whether to enable or disable the feedback based on a service reliability requirement.

In some embodiments, when determining the feedback configuration, if the feedback is to be enabled, the network device 110 may determine, based on the number of the plurality of terminal devices 120, a feedback transmission scheme for the plurality of terminal devices 120 to transmit the feedback to the network device 110, and may configure the feedback configuration to indicate the feedback transmission scheme.

In some embodiments, the feedback configuration is to be indicated by a feedback timing indicator in the control information, when the network device 110 configures the feedback configuration to indicate the feedback transmission scheme, the network device 110 can determine an index of a feedback timing value based on a predetermined association between the index of the feedback timing value and the feedback transmission scheme, and can set the feedback timing indicator to indicate the index of the feedback timing value.

In some embodiments, the feedback configuration is to be indicated by a feedback resource indicator in the control information, when the network device 110 configures the feedback configuration to indicate the feedback transmission scheme, the network device 110 may determine an index of a feedback resource based on a predetermined association between the index of the feedback resource and the feedback transmission scheme, and may set the feedback resource indicator to indicate the index of the feedback resource.

In some embodiments, the feedback configuration is to be indicated by a feedback resource indicator in the control information, when the network device 110 configures the feedback configuration to indicate the feedback transmission scheme, the network device 110 can set, based on the feedback transmission scheme, the feedback resource indicator to indicate a common resource for the plurality of terminal devices 120 to transmit the feedback.

In some embodiments, whether the feedback is enabled or disabled is to be indicated by a first bit in a dedicated field in the control information, when the network device 110 configures the feedback configuration to indicate the feedback transmission scheme, the network device 110 may set a second bit in the dedicated field to indicate the feedback transmission scheme.

In some embodiments, the feedback being disabled is to be indicated by a predetermined value of a dedicated field in the control information, when the network device 110 configures the feedback configuration to indicate the feedback transmission scheme, the network device 110 can set a value of the dedicated field different from the predetermined value to indicate the feedback transmission scheme.

### Example Apparatus

FIG. 8 is a simplified block diagram of an apparatus 800 (also termed as a device 800) that is suitable for implementing embodiments of the present disclosure. The apparatus 800 can be considered as a further example implementation of the network device 110 and the terminal devices 120 as shown in FIGS. 1A to 1C. Accordingly, the apparatus 800 can be implemented at or as at least a part of the network device 110 and the terminal devices 120.

As shown, the apparatus 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the apparatus 800 to operate in accordance with the embodiments of the present disclosure, as discussed herein. The embodiments herein may be implemented by computer software executable by the processor 810 of the apparatus 800, or by hardware, or by a combination of software and hardware. The processor 810 may be configured to implement various embodiments of the present disclosure. Furthermore, a combination of the processor 810 and memory 810 may form processing means 850 adapted to implement various embodiments of the present disclosure.

The memory 810 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 810 is shown in the apparatus 800, there may be several physically distinct memory modules in the apparatus 800. The processor 810 may be of any type suitable to the local technical network, and may include one or more of general purpose computers, special purpose computers, microprocessors, digital signal processors (DSPs) and processors based on multicore processor architecture, as non-limiting examples. The apparatus 800 may have multiple processors, such as an application specific integrated circuit chip that is slaved in time to a clock which synchronizes the main processor.

In some embodiments, an apparatus capable of performing the example method 600 (for example, the terminal device 120-1) may comprise means for performing the respective steps of the example method 600. The means may be implemented in any suitable form. For example, the means may be implemented in a circuitry or software module.

In some embodiments, the apparatus comprises means for receiving, from a network device, control information for scheduling a shared channel transmission common to a plurality of terminal devices including the terminal device. The apparatus also comprises means for determining, based on the control information, a feedback configuration indicating whether feedback for the shared channel transmission is enabled or disabled. The apparatus further comprises means for performing a communication with the network device based on the feedback configuration.

In some embodiments, the means for determining the feedback configuration comprises: means for determining the feedback configuration based on a feedback timing indicator in the control information.

In some embodiments, the means for determining the feedback configuration based on the feedback timing indicator comprises: means for in accordance with a determination that the feedback timing indicator has a value indicating an inapplicable feedback timing value, determining that the feedback configuration indicates that the feedback is disabled; and means for in accordance with a determination that the feedback timing indicator has a value indicating an applicable feedback timing value, determining that the feedback configuration indicates that the feedback is enabled.

In some embodiments, the means for determining the feedback configuration based on the feedback timing indicator comprises: means for in accordance with a determination that the feedback timing indicator has a predetermined value, determining that the feedback configuration indicates that the feedback is disabled; and means for in accordance with a determination that the feedback timing indicator has a value different from the predetermined value, determining that the feedback configuration indicates that the feedback is enabled.

In some embodiments, the means for determining the feedback configuration comprises: means for determining the feedback configuration based on a feedback resource indicator in the control information.

In some embodiments, the means for determining the feedback configuration based on the feedback resource indicator comprises: means for in accordance with a determination that the feedback resource indicator has a value indicating an inapplicable resource, determining that the feedback configuration indicates that the feedback is disabled; and means for in accordance with a determination that the feedback resource indicator has a value indicating an applicable resource, determining that the feedback configuration indicates that the feedback is enabled.

In some embodiments, the means for determining the feedback configuration based on the feedback resource indicator comprises: means for in accordance with a determination that the feedback resource indicator has a predetermined value, determining that the feedback configuration indicates that the feedback is disabled; and means for in accordance with a determination that the feedback resource indicator has a value different from the predetermined value, determining that the feedback configuration indicates that the feedback is enabled.

In some embodiments, the means for determining the feedback configuration comprises: means for determining the feedback configuration based on a dedicated field in the control information.

In some embodiments, the means for determining the feedback configuration based on the dedicated field comprises: means for in accordance with a determination that a first bit in the dedicated field has a first value, determining that the feedback configuration indicates that the feedback is disabled; and means for in accordance with a determination that the first bit has a second value, determining that the feedback configuration indicates that the feedback is enabled.

In some embodiments, the means for determining the feedback configuration based on the dedicated field comprises: means for in accordance with a determination that the dedicated field has a predetermined value, determining that the feedback configuration indicates that the feedback is disabled; and means for in accordance with a determination that the dedicated field has a value different from the predetermined value, determining that the feedback configuration indicates that the feedback is enabled.

In some embodiments, the means for performing the communication based on the feedback configuration comprises: means for in accordance with a determination that the feedback configuration indicates that the feedback is disabled, receiving the shared channel transmission without transmitting the feedback to the network device.

In some embodiments, the means for performing the communication based on the feedback configuration comprises: means for in accordance with a determination that the feedback configuration indicates that the feedback is enabled, determining a feedback transmission scheme indicated by the feedback configuration; and transmitting the feedback to the network device based on the feedback transmission scheme.

In some embodiments, the feedback configuration is determined based on a feedback timing indicator in the control information, and the means for determining the feedback transmission scheme comprises: means for determining, from the feedback timing indicator, an index of a feedback timing value; and means for determining the feedback transmission scheme based on a predetermined association between the index of the feedback timing value and the feedback transmission scheme.

In some embodiments, the feedback configuration is determined based on a feedback resource indicator in the control information, and the means for determining the feedback transmission scheme comprises: means for determining, from the feedback resource indicator, an index of a resource for the feedback; and means for determining the feedback transmission scheme based on a predetermined association between the index of the resource and the feedback transmission scheme.

In some embodiments, the feedback configuration is determined based on a feedback resource indicator in the control information, and the means for determining the feedback transmission scheme comprises: means for determining whether the feedback resource indicator indicates a common resource for the plurality of terminal devices to transmit feedback for the shared channel transmission; and means for determining the feedback transmission scheme based on a result of the determination.

In some embodiments, a first bit in a dedicated field in the control information indicates whether the feedback is enabled or disabled, and the means for determining the feedback transmission scheme comprises: means for determining the feedback transmission scheme based on a second bit in the dedicated field.

In some embodiments, a predetermined value of a dedicated field in the control information indicates that the feedback is disabled, and the means for determining the feedback transmission scheme comprises: means for determining the feedback transmission scheme based on a value of the dedicated field different from the predetermined value.

In some embodiments, the means for transmitting the feedback to the network device comprises: means for in accordance with a determination that the shared channel transmission is unsuccessfully received by the terminal device, transmitting negative feedback to the network device using a resource common to the plurality of terminal devices.

In some embodiments, the means for transmitting the feedback to the network device comprises: means for in accordance with a determination that the shared channel transmission is successfully received by the terminal device, transmitting positive feedback to the network device using a resource specific to the terminal device; and means for in accordance with a determination that the shared channel transmission is unsuccessfully received by the terminal device, transmitting negative feedback to the network device using the resource specific to the terminal device.

In some embodiments, the apparatus further comprises means for performing other steps in some embodiments of the example method 600. In some embodiments, the means comprises at least one processor and at least one memory including computer program code, the at least one memory and computer program code configured to, with the at least one processor, cause the performance of the example method 600.

In some embodiments, an apparatus capable of performing the example method 700 (for example, the network device 110) may comprise means for performing the respective steps of the example method 700. The means may be implemented in any suitable form. For example, the means may be implemented in a circuitry or software module.

In some embodiments, the apparatus comprises means for determining a feedback configuration indicating whether feedback for a shared channel transmission is enabled or disabled, the shared channel transmission being common to a plurality of terminal devices. The apparatus also comprises means for generating control information for scheduling the shared channel transmission and indicating the feedback configuration. The apparatus further comprises means for transmitting the control information to at least one of the plurality of terminal devices.

In some embodiments, the means for generating the control information comprises: means for setting a feedback timing indicator in the control information to indicate the feedback configuration.

In some embodiments, the means for setting the feedback timing indicator comprises: means for in accordance with a determination that the feedback is to be disabled, setting the feedback timing indicator to have a value indicating an inapplicable feedback timing value; and means for in accordance with a determination that the feedback is to be enabled, setting the feedback timing indicator to have a value indicating an applicable feedback timing value.

In some embodiments, the means for setting the feedback timing indicator comprises: means for in accordance with a determination that the feedback is to be disabled, setting the feedback timing indicator to have a predetermined value; and means for in accordance with a determination that the feedback is to be enabled, setting the feedback timing indicator to have a value different from the predetermined value.

In some embodiments, the means for generating the control information comprises: means for setting a feedback resource indicator in the control information to indicate the feedback configuration.

In some embodiments, the means for setting the feedback resource indicator comprises: means for in accordance with a determination that the feedback is to be disabled, setting the feedback resource indicator to have a value indicating an inapplicable resource; and means for in accordance with a determination that the feedback is to be enabled, setting the feedback resource indicator to have a value indicating an applicable resource.

In some embodiments, the means for setting the feedback resource indicator comprises: means for in accordance with a determination that the feedback is to be disabled, setting the feedback resource indicator to have a predetermined value; and means for in accordance with a determination that the feedback is to be enabled, setting the feedback resource indicator to have a value different from the predetermined value.

In some embodiments, the means for generating the control information comprises: means for setting a dedicated field in the control information to indicate the feedback configuration.

In some embodiments, the means for setting the dedicated field comprises: means for in accordance with a determination that the feedback is to be disabled, setting a first bit in the dedicated field to have a first value; and means for in accordance with a determination that the feedback is to be enabled, setting the first bit to have a second value.

In some embodiments, the means for setting the dedicated field comprises: means for in accordance with a determination that the feedback is to be disabled, setting the dedicated field to have a predetermined value; and means for in accordance with a determination that the feedback is to be enabled, setting the dedicated field to have a value different from the predetermined value.

In some embodiments, the means for determining the feedback configuration comprises: means for determining whether to enable or disable the feedback based on a service reliability requirement.

In some embodiments, the means for determining the feedback configuration further comprises: means for in accordance with a determination that the feedback is to be enabled, determining, based on the number of the plurality of terminal devices, a feedback transmission scheme for the plurality of terminal devices to transmit the feedback to the network device; and means for configuring the feedback configuration to indicate the feedback transmission scheme.

In some embodiments, the feedback configuration is to be indicated by a feedback timing indicator in the control information, and the means for configuring the feedback configuration to indicate the feedback transmission scheme comprises: means for determining an index of a feedback timing value based on a predetermined association between the index of the feedback timing value and the feedback transmission scheme; and means for setting the feedback timing indicator to indicate the index of the feedback timing value.

In some embodiments, the feedback configuration is to be indicated by a feedback resource indicator in the control information, and the means for configuring the feedback configuration to indicate the feedback transmission scheme comprises: means for determining an index of a feedback resource based on a predetermined association between the index of the feedback resource and the feedback transmission scheme; and means for setting the feedback resource indicator to indicate the index of the feedback resource.

In some embodiments, the feedback configuration is to be indicated by a feedback resource indicator in the control information, and the means for configuring the feedback configuration to indicate the feedback transmission scheme comprises: means for setting, based on the feedback transmission scheme, the feedback resource indicator to indicate a common resource for the plurality of terminal devices to transmit the feedback.

In some embodiments, whether the feedback is enabled or disabled is to be indicated by a first bit in a dedicated field in the control information, and the means for configuring the feedback configuration to indicate the feedback transmission scheme comprises: means for setting a second bit in the dedicated field to indicate the feedback transmission scheme.

In some embodiments, the feedback being disabled is to be indicated by a predetermined value of a dedicated field in the control information, and the means for configuring the feedback configuration to indicate the feedback transmission scheme comprises: means for setting a value of the dedicated field different from the predetermined value to indicate the feedback transmission scheme.

In some embodiments, the apparatus further comprises means for performing other steps in some embodiments of the example method 700. In some embodiments, the means comprises at least one processor and at least one memory including computer program code, the at least one memory and computer program code configured to, with the at least one processor, cause the performance of the example method 700.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method performed by a terminal device, comprising:
receiving, from a network device, control information for scheduling a shared channel transmission common to a plurality of terminal devices including the terminal device;
determining, based on the control information, a feedback configuration indicating whether feedback for the shared channel transmission is enabled or disabled; and
performing a communication with the network device based on the feedback configuration.

2. The method of claim 1, wherein determining the feedback configuration comprises:
determining the feedback configuration based on at least one of a feedback timing indicator, a feedback resource indicator, or a dedicated field in the control information.

3. The method of claim 2, wherein determining the feedback configuration based on the feedback timing indicator comprises one of:
in accordance with a determination that the feedback timing indicator has a value indicating an inapplicable feedback timing value, determining that the feedback configuration indicates the feedback is disabled;
in accordance with the determination that the feedback timing indicator has the value indicating an applicable feedback timing value, determining that the feedback configuration indicates the feedback is enabled;
in accordance with the determination that the feedback timing indicator has a predetermined value, determining that the feedback configuration indicates the feedback is disabled; or
in accordance with the determination that the feedback timing indicator has a different value than the predetermined value, determining that the feedback configuration indicates the feedback is enabled.

4. The method of claim 2, wherein determining the feedback configuration based on the feedback resource indicator comprises one of:
in accordance with a determination that the feedback resource indicator has a value indicating an inapplicable resource, determining that the feedback configuration indicates the feedback is disabled;
in accordance with the determination that the feedback resource indicator has the value indicating an applicable resource, determining that the feedback configuration indicates the feedback is enabled;
in accordance with the determination that the feedback resource indicator has a predetermined value, determining that the feedback configuration indicates the feedback is disabled; or
in accordance with the determination that the feedback resource indicator has a different value than the predetermined value, determining that the feedback configuration indicates the feedback is enabled.

5. The method of claim 2, wherein determining the feedback configuration based on the dedicated field comprises one of:
in accordance with a determination that a first bit in the dedicated field has a first value, determining that the feedback configuration indicates the feedback is disabled;
in accordance with the determination that the first bit has a second value, determining that the feedback configuration indicates the feedback is enabled;
in accordance with the determination that the dedicated field has a predetermined value, determining that the feedback configuration indicates the feedback is disabled; or
in accordance with the determination that the dedicated field has a different value than the predetermined value, determining that the feedback configuration indicates the feedback is enabled.

6. The method of claim 1, wherein performing the communication based on the feedback configuration comprises:
in accordance with a determination that the feedback configuration indicates the feedback is disabled, receiving the shared channel transmission without transmitting the feedback to the network device.

7. The method of claim 1, wherein performing the communication based on the feedback configuration comprises:
in accordance with a determination that the feedback configuration indicates the feedback is enabled, determining a feedback transmission scheme indicated by the feedback configuration; and
transmitting the feedback to the network device based on the feedback transmission scheme.

8. The method of claim 7, wherein the feedback configuration is determined based on a feedback timing indicator in the control information, and wherein determining the feedback transmission scheme comprises:
determining, from the feedback timing indicator, an index of a feedback timing value; and
determining the feedback transmission scheme based on a predetermined association between the index of the feedback timing value and the feedback transmission scheme.

9. The method of claim 7, wherein the feedback configuration is determined based on a feedback resource indicator in the control information, and wherein determining the feedback transmission scheme comprises:
determining, from the feedback resource indicator, an index of a resource for the feedback; and
determining the feedback transmission scheme based on a predetermined association between the index of the resource and the feedback transmission scheme.

10. The method of claim 7, wherein the feedback configuration is determined based on a feedback resource indicator in the control information, and wherein determining the feedback transmission scheme comprises:
determining whether the feedback resource indicator indicates a common resource for the plurality of terminal devices to transmit the feedback for the shared channel transmission; and
determining the feedback transmission scheme based on the determination of whether the feedback resource indicator indicates the common resource for the plurality of terminal devices.

11. The method of claim 7, wherein a first bit in a dedicated field in the control information indicates whether the feedback is enabled or disabled, and wherein determining the feedback transmission scheme comprises:
determining the feedback transmission scheme based on a second bit in the dedicated field.

12. The method of claim 7, wherein a predetermined value of a dedicated field in the control information indicates that the feedback is disabled, and wherein determining the feedback transmission scheme comprises:
determining the feedback transmission scheme based on a value of the dedicated field being different from the predetermined value.

13. The method of claim 7, wherein transmitting the feedback to the network device comprises:
in accordance with the determination that the shared channel transmission is unsuccessfully received by the terminal device, transmitting negative feedback to the network device using a resource common to the plurality of terminal devices.

14. The method of claim 7, wherein transmitting the feedback to the network device comprises:
in accordance with the determination that the shared channel transmission is successfully received by the terminal device, transmitting positive feedback to the network device using a resource specific to the terminal device; and
in accordance with the determination that the shared channel transmission is unsuccessfully received by the terminal device, transmitting negative feedback to the network device using the resource specific to the terminal device.

15. A terminal device comprising:
a processor; and
a memory coupled with the processor, the processor configured to cause the terminal device to:
receive, from a network device, control information for scheduling a shared channel transmission common to a plurality of terminal devices including the terminal device;
determine, based at least in part on the control information, a feedback configuration indicating whether feedback for the shared channel transmission is enabled or disabled; and
perform a communication with the network device based at least in part on the feedback configuration.

16. The terminal device of claim 15,
wherein the feedback configuration is determined based on at least one of a feedback timing indicator, a feedback resource indicator, or a dedicated field in the control information.

17. The terminal device of claim 15, wherein the communication with the network device includes the processor is configured to cause the terminal device to receive the shared channel transmission without the feedback being transmitted to the network device based at least in part on the feedback configuration indicates the feedback is disabled.

18. The terminal device of claim 15, wherein the communication based at least in part on the feedback configuration includes the processor is configured to cause the terminal device to:
determine a feedback transmission scheme indicated by the feedback configuration based at least in part on the feedback configuration indicates the feedback is enabled; and
transmit the feedback to the network device based on the feedback transmission scheme.

19. A network device, comprising:
a processor; and
a memory coupled with the processor, the processor configured to cause the network device to:
transmit, to a terminal device, control information for scheduling a shared channel transmission common to a plurality of terminal devices including the terminal device; and
perform a communication with the terminal device based at least in part on a feedback configuration determined at the terminal device based at least in part on the control information, the feedback configuration indicating whether feedback for the shared channel transmission is enabled or disabled.

20. The network device of claim 19, wherein the processor is configured to cause the network device to receive the feedback from the terminal device based at least in part on a feedback transmission scheme indicated by the feedback configuration.
